(19) United States
(12) Patent Application Publication
(10) Pub. No.: US 2026/0291077 A1
(43) Pub. Date: Sep. 24, 2026

(54) RADIATING ELEMENTS HAVING CLOAKED FEED STALKS AND/OR CLOAKED FEED CABLES

(71) Applicant: Outdoor Wireless Networks LLC, Richardson, TX (US)

(72) Inventors: Bo Wu, Allen, TX (US); Peter J. Bisiules, LaGrange Park, IL (US); Chengcheng Tang, Murphy, TX (US)

(21) Appl. No.: 19/477,937

(22) PCT Filed: Apr. 22, 2024
(86) PCT No.: PCT/US2024/025640

§ 371 Date: Oct. 23, 2025

Related U.S. Application Data
(60) Provisional application No. 63/463,681, filed on May 3, 2023.
(60) Provisional application No. 63/528,689, filed on Jul. 25, 2023.

(51) Int. Cl. H01Q 15/00; H01Q 9/04; H01Q 13/20

(52) U.S. Cl. CPC H01Q 15/0086; H01Q 9/0464; H01Q 13/206

(57) ABSTRACT

A radiating element comprises a feed stalk and a radiator mounted on the feed stalk. The feed stalk includes a signal line, a first ground line and a ring-based metamaterial resonator.

### CROSS-REFERENCE TO RELATED APPLICATIONS

The present application claims priority to U.S. Provisional Application Ser. No. 63/463,681, filed May 3, 2023 and to U.S. Provisional Application Ser. No. 63/528,689, filed Jul. 25, 2023, the entire content of each of which is incorporated herein by reference.

### BACKGROUND

The present invention generally relates to radio communications and, more particularly, to base station antennas for cellular communications systems and to radiating elements for such base station antennas.

Cellular communications systems are well known in the art. In a cellular communications system, a geographic area is divided into a series of regions that are referred to as “cells” which are served by respective base stations. Each base station may include one or more base station antennas that are configured to provide two-way radio frequency (“RF”) communications with fixed and mobile subscribers that are within the cell served by the base station. Typically, the base station antennas are mounted on a tower or other raised structure, with the radiation patterns (also referred to herein as “antenna beams”) that are generated by the base station antennas directed outwardly.

A common base station configuration is the three sector configuration in which a cell is divided into three 120° “sectors” in the azimuth (horizontal) plane. A separate base station antenna provides coverage (service) to each sector. Typically, each base station antenna will include multiple vertically-extending columns of radiating elements that operate, for example, using second generation (“2G”), third generation (“3G”) or fourth generation (“4G”) cellular network protocols. These vertically-extending columns of radiating elements are typically referred to as “linear arrays,” and may be straight columns or columns in which some of the radiating elements are staggered horizontally. Most modem base station antennas include both “low-band” linear arrays of radiating elements that support service in some or all of the 617-960 MHz frequency band and “mid-band” linear arrays of radiating elements that support service in some or all of the 1427-2690 MHz frequency band. These linear arrays are typically formed using dual-polarized radiating elements, which allows each linear array to simultaneously transmit and receive RF signals at two orthogonal polarizations.

Each of the above-described linear arrays is coupled to two ports of a radio (one port for each polarization). An RF signal that is to be transmitted by a linear array is passed from the radio port to the antenna where it is divided into a plurality of sub-components, with each sub-component fed to a respective subset of the radiating elements in the linear array (typically each sub-component is fed to between one and three radiating elements). The sub-components of the RF signal are transmitted through the radiating elements to generate an antenna beam that covers a generally fixed coverage area, such as a sector of a cell. The relative phases of the sub-components of the RF signal are set (e.g., using phase delay lines) so that the individual antenna beams generated by each subset of radiating elements constructively combine to narrow the half power beamwidth (“HPBW”) of the generated antenna beams in the elevation (vertical) plane. Since the above-described 2G/3G/4G linear arrays generate static antenna beams, they are often referred to as “passive” linear arrays.

Most cellular operators are currently upgrading their networks to support fifth generation (“5G”) cellular service. One important component of 5G cellular service is the use of so-called “active” beamforming arrays that operate in conjunction with active beamforming radios to dynamically adjust the size, shape and pointing direction of the antenna beams that are generated by the active beamforming array. These active beamforming arrays include multiple columns of radiating elements, with eight columns being the most common. Active beamforming arrays are typically formed using “high-band” radiating elements that operate in higher frequency bands, such as some or all of the 3.1-4.2 GHz and/or the 5.1-5.8 GHz frequency bands, although active beamforming arrays may also be provided that operate in the upper portion of the mid-band frequency range (e.g., 2300-2690 MHz). Each column of radiating elements of such an active beamforming array is typically coupled to a respective port of a beamforming radio. The beamforming radio may be a separate device, or may be integrated with the active antenna array. The beamforming radio may dynamically adjust the amplitudes and phases of the sub-components of an RF signal that are fed to each port of the radio in order to generate antenna beams that have narrowed beamwidths in the azimuth plane (and hence higher antenna gain). These narrowed antenna beams can be electronically steered in the azimuth plane by proper selection of the amplitudes and phases of the sub-components of an RF signal.

In order to avoid having to increase the number of antennas at cell sites, the above-described 5G antennas often include passive linear arrays that support legacy 2G, 3G and/or 4G cellular services. In one popular solution, a 5G active antenna module (i.e., a module that includes an active beamforming array and associated beamforming radio) is mounted on the rear surface of a passive base station antenna that includes a plurality of 2G, 3G, and/or 4G passive linear arrays. An opening is provided in the reflector of the passive base station antenna so that the antenna beams generated by the active beamforming array can be transmitted through the passive base station antenna. Typically, some of the radiating elements of the 2G/3G/4G passive linear arrays are mounted in front of the radiating elements of the beamforming array. The above-described antenna design is advantageous as the active antenna module may be removable, and hence as enhanced 5G capabilities are developed, a cellular operator may replace the original active antenna module with an upgraded active antenna module without having to replace the passive base station antenna. Herein, the combination of a passive base station antenna that has an active antenna module mounted thereon is referred to as a “passive/active antenna system.”

### SUMMARY

Pursuant to embodiments of the present invention, radiating elements are provided that comprise a feed stalk having a signal line, a first ground line and a ring-based metamaterial resonator; as well as a radiator mounted on the feed stalk.

In some embodiments, the ring-based metamaterial resonator overlaps the first ground line. In some embodiments, the ring-based metamaterial resonator comprises a complementary split ring resonator or a split ring resonator.

In some embodiments, the feed stalk comprises a first plurality of ring-based metamaterial resonators, with the ring-based metamaterial resonator being one of the first plurality of ring-based metamaterial resonators, and the first plurality of ring-based metamaterial resonators overlap at least 50% of the first ground line. In some embodiments, the feed stalk further comprises a second ground line and a second plurality of ring-based metamaterial resonators that overlap at least 50% of the second ground line. In some embodiments, the feed stalk comprises a feed stalk printed circuit board having a dielectric substrate with first and second metallization patterns on opposed first and second major surfaces thereof, with the signal line and the ring-based metamaterial resonator being at least part of the first metallization pattern and the first and second ground lines being at least part of the second metallization pattern. In some embodiments, the signal line comprises a first segment that overlaps the first ground line, a third segment that overlaps the second ground line and a second segment that connects the first segment to the third segment. In some embodiments, the signal line is in between the first plurality of ring-based metamaterial resonators and the second plurality of ring-based metamaterial resonators overlap the second ground line.

In some embodiments, the feed stalk comprises a feed stalk printed circuit board having a first dielectric substrate with a first metallization pattern thereon, a second dielectric substrate with a third metallization pattern thereon and a second metallization pattern positioned between the first and second dielectric substrates, with the ring-based metamaterial resonator being part of the first metallization pattern, the signal line being at least part of the second metallization pattern, and the first ground line being part of the third metallization pattern.

In some embodiments, the radiator is mounted on a forward end of the feed stalk, and the ring-based metamaterial resonator overlaps a portion of the first ground line that is positioned forwardly of the signal line.

In some embodiments, any of the above-described radiating element may be included in a base station antenna that further includes a second radiating element that is configured to operate in a higher operating frequency band than the first radiating element, where the ring-based metamaterial resonator is configured to operate as a bandpass filter having a passband that encompasses at least a portion of the higher operating frequency band. In some embodiments, the first radiating element may be mounted forwardly of the second radiating element.

Pursuant to further embodiments of the present invention, radiating elements are provided that each comprise a radiator and a feed stalk printed circuit board that includes at least a first dielectric substrate, a first metallization pattern that extends in a longitudinal direction of the feed stalk printed circuit board on a first outer surface of the dielectric substrate, and a second metallization pattern that comprises a plurality of ring-based metamaterial resonators.

In some embodiments, the first metallization pattern comprises first and second ground lines. In some embodiments, the second metallization pattern further comprises a signal line that is positioned between first and second of the ring-based metamaterial resonators in the plurality of ring-based metamaterial resonators. In some embodiments, the plurality of ring-based metamaterial resonators comprises a first plurality of ring-based metamaterial resonators and a second plurality of ring-based metamaterial resonators. In some embodiments, the first plurality of ring-based metamaterial resonators overlaps the first ground line.

In some embodiments, the plurality of ring-based metamaterial resonators comprises a plurality of complementary split ring resonators or a plurality of split ring resonators.

In some embodiments, the second metallization pattern is on a second outer surface of the first dielectric substrate.

In some embodiments, the feed stalk printed circuit board further comprises a second dielectric substrate, wherein the second metallization pattern is on an outer surface of the second dielectric substrate, and the feed stalk further comprises a signal line that is part of a third metallization pattern that is positioned between the first and second dielectric substrates. In some embodiments, the signal line comprises a first segment that overlaps the first ground line, a third segment that overlaps the second ground line and a second segment that connects the first segment to the third segment. In some embodiments, the plurality of ring-based metamaterial resonators comprises a first plurality of ring-based metamaterial resonators and a second plurality of ring-based metamaterial resonators, wherein the first plurality of ring-based metamaterial resonators overlap the first ground line, and the second plurality of ring-based metamaterial resonators overlap the second ground line.

In some embodiments, the signal line and the first and second ground lines together comprise an RF feed line.

Pursuant to still further embodiments of the present invention, base station antennas are provided that comprise a first radiating element that is configured to operate in a first operating frequency band and a second radiating element that is configured to operate in a second operating frequency band that encompasses higher frequencies than the first operating frequency band. A feed stalk of the first radiating element comprises a radio frequency (“RF”) feed line that includes a filter that has a pass band in the first operating frequency band and a stop band in the second operating frequency band.

In some embodiments, the filter includes an inductor that is electrically in series with a first capacitor. In some embodiments, the RF feed line includes a signal line and a first ground line, and wherein the inductor is part of the first ground line. In some embodiments, the inductor comprises a meandered conductive trace that has an average width that is less than half an average width of a remainder of the first ground line. In some embodiments, the filter further includes a second capacitor that is in parallel with the series combination of the inductor and the first capacitor.

In some embodiments, the filter is implemented on a first feed stalk printed circuit board of the feed stalk, and the filter is positioned in between the signal line and a dipole radiator printed circuit board of the first radiating element. In some embodiments, the base station antenna further comprises a metamaterial structure on the first feed stalk printed circuit board, the metamaterial structure overlapping the first ground line. In some embodiments, the metamaterial structure comprises a ring-based metamaterial resonator.

Pursuant to additional embodiments of the present invention, coaxial cables are provided that comprise a center conductor, an outer conductor, a dielectric spacer between the center conductor and the outer conductor, and an insulating cable jacket covering the outer conductor. A plurality of metamaterial structures are provided on the insulating cable jacket.

In some embodiments, the metamaterial structures comprise a plurality of ring-based metamaterial resonators. The plurality of ring-based metamaterial resonators may comprise, for example, a plurality of complementary split ring resonators or a plurality of split ring resonators.

In some embodiments, the plurality of ring-based metamaterial resonators extend on the insulating cable jacket in a longitudinal direction of the coaxial cable.

In some embodiments, the coaxial cable is provided in a base station antenna that includes a plurality of first radiating elements that are configured to operate in a first frequency band and a plurality of second radiating elements that are configured to operate in a second frequency band that encompasses higher frequencies than the first frequency band, and the metamaterial structures are configured to cancel currents in the second frequency band. In some embodiments, coaxial cable is a feed cable for one of the first radiating elements.

Pursuant to further embodiments of the present invention, radiating elements are provided that comprise a feed stalk having a signal line, a first ground line and a first metal stub that extends in parallel to a first section of the first ground line, and a radiator mounted on the feed stalk. The first metal stub is configured to capacitively couple with the first section of the first ground line.

In some embodiments, the signal line, the first ground line and the first metal stub are implemented on a feed stalk printed circuit board.

In some embodiments, the radiating element further comprises a second metal stub that extends in parallel to the first section of the first ground line, where the second metal stub is configured to capacitively couple with the first section of the first ground line.

In some embodiments, the first metal stub, the second metal stub and the first section of the first ground line are all on a first metallization layer of the feed stalk printed circuit board. In some embodiments, the first metal stub is on a first side of the first section of the ground line and the second metal stub is on a second side of the first section of the first ground line that is opposite the first side.

In some embodiments, the radiating element further comprises a third metal stub that extends in parallel to a second section of the first ground line, where the third metal stub is configured to capacitively couple with the first ground line and a fourth metal stub that extends in parallel to the second section of the first ground line, where the fourth metal stub is configured to capacitively couple with the first ground line.

In some embodiments, the radiating element further comprises a first additional metal stub that overlaps the first metal stub and a second additional metal stub that overlaps the second metal stub, where the first additional metal stub, the second additional metal stub and at least a first portion of the signal line are all on a second metallization layer of the feed stalk printed circuit board that is different than the first metallization layer.

In some embodiments, a first conductive via in the feed stalk printed circuit board galvanically connects the first metal stub to the first additional metal stub, and a second conductive via in the feed stalk printed circuit board galvanically connects the second metal stub to the second additional metal stub.

In some embodiments, the first portion of the signal line is between the first additional metal stub and the second additional metal stub.

In some embodiments, the first metal stub and the first section of the first ground line together comprise at least a portion of inductor-capacitor circuit that has a band pass filter response. In some embodiments, the radiating element is part of a base station antenna, and the base station antenna includes a second radiating element that has an operating frequency band, and a frequency in the band pass filter response having the highest transmission level is within the operating frequency band.

In some embodiments, a width of the first section of the first ground line is less than half a width of another section of the first ground line.

In some embodiments, the first metal stub is not galvanically connected to either the first ground line or the signal line.

Pursuant to additional embodiments of the present invention, radiating elements are provided that comprise a feed stalk having a signal line and a first ground line and a radiator mounted on the feed stalk. In these radiating elements, a first section of the first ground line is part of a resonant circuit that is configured to have a band pass response in a preselected frequency range.

In some embodiments, the radiating element has a first operating frequency band and is part of a base station antenna, the base station antenna further including a second radiating element that has a second operating frequency band, and a pass band of the band pass response is at least partly within the second operating frequency band.

In some embodiments, the feed stalk further includes a first metal stub that is configured to capacitively couple with the first ground line. In some embodiments, the first metal stub extends in parallel to a first section of the first ground line.

In some embodiments, the signal line, the first ground line and the first metal stub are implemented on a feed stalk printed circuit board, and the first section of the ground line and the first metal stub are both on a first metallization layer of the feed stalk printed circuit board.

In some embodiments, the radiating element further comprises a second metal stub that extends in parallel to the first section of the first ground line, where the second metal stub is configured to capacitively couple with the first ground line.

In some embodiments, the radiating element further comprises a first additional metal stub that overlaps the first metal stub and a second additional metal stub that overlaps the second metal stub, where the first additional metal stub, the second additional metal stub and at least a first portion of the signal line are all on a second metallization layer of the feed stalk printed circuit board that is different than the first metallization layer.

In some embodiments, the first portion of the signal line is between the first additional metal stub and the second additional metal stub.

In some embodiments, a first conductive via in the feed stalk printed circuit board galvanically connects the first metal stub to the first additional metal stub, and a second conductive via in the feed stalk printed circuit board galvanically connects the second metal stub to the second additional metal stub.

Pursuant to still further embodiments of the present invention, radiating elements are provided that comprise a feed stalk printed circuit board having a signal line, a first ground line, first and second metal stubs that are opposed sides of a first section of the first ground line, and first and second additional metal stubs that overlap the respective first and second metal stubs and a radiator mounted on the feed stalk.

In some embodiments, the first ground line and the first and second metal stubs are each part of a first metallization layer of the feed stalk printed circuit board and the first and second additional metal stubs are each part of a second metallization layer of the feed stalk printed circuit board.

In some embodiments, the first and second metal stubs are configured to capacitively couple with the first ground line.

In some embodiments, the radiating element further comprises a third metal stub that extends in parallel to a second section of the first ground line, where the third metal stub is configured to capacitively couple with the first ground line and is part of the first metallization layer and a fourth metal stub that extends in parallel to the second section of the first ground line, where the fourth metal stub is configured to capacitively couple with the first ground line and is part of the first metallization layer.

In some embodiments, the radiating element further comprise a third additional metal stub that overlaps the third metal stub and a fourth additional metal stub that overlaps the fourth metal stub, where the third additional metal stub and the fourth additional metal stub are all part of the second metallization layer of the feed stalk printed circuit board.

In some embodiments, a first conductive via in the feed stalk printed circuit board galvanically connects the first metal stub to the first additional metal stub, and a second conductive via in the feed stalk printed circuit board galvanically connects the second metal stub to the second additional metal stub.

In some embodiments, the second metallization layer of the feed stalk printed circuit board further includes a signal line and at least a first portion of the signal line is between the first additional metal stub and the second additional metal stub.

In some embodiments, the first metal stub and the first section of the first ground line together comprise at least a portion of inductor-capacitor circuit that has a band pass filter response.

In some embodiments, the radiating element is part of a base station antenna that includes a second radiating element that has an operating frequency band, and a frequency in the band pass filter response having the highest transmission level is within the operating frequency band.

In some embodiments, a width of the first section of the first ground line is less than half a width of another section of the first ground line.

### BRIEF DESCRIPTION OF THE DRAWINGS

FIG. 1A is a schematic perspective view of a conventional low-band cross-dipole radiating element.

FIG. 1B is a schematic side view of the conventional low-band cross-dipole radiating element of FIG. 1A.

FIG. 2A is a schematic perspective view of a passive/active antenna system that includes a passive base station antenna that may be implemented using low-band radiating elements according to embodiments of the present invention.

FIG. 2B is a schematic front view of the passive/active antenna system of FIG. 2A with the radomes and a frequency selective surface thereof omitted.

FIG. 3A is a schematic perspective view of a radiating element according to embodiments of the present invention.

FIG. 3B is a schematic side view of one of the feed stalk printed circuit boards included in the radiating element of FIG. 3A.

FIG. 3C is a schematic plan view of a first outer surface of the feed stalk printed circuit board of FIG. 3A.

FIG. 3D is a schematic plan view of an interior metal layer of the feed stalk printed circuit board of FIG. 3B.

FIG. 3E is a schematic plan view of a second outer surface of the feed stalk printed circuit board of FIG. 3B.

FIG. 3F is a schematic shadow plan view of the feed stalk printed circuit board of FIGS. 3B-3E that illustrates all three metallization layers thereof.

FIG. 3G is a circuit diagram of an equivalent circuit for a split ring resonator.

FIG. 4A is a schematic plan view of a first outer surface of a feed stalk printed circuit board that may be used in place of the feed stalk printed circuit board included in the radiating element of FIG. 3A.

FIG. 4B is a schematic plan view of a second outer surface of the feed stalk printed circuit board of FIG. 4A.

FIG. 4C is a schematic shadow plan view of the feed stalk printed circuit board of FIGS. 4A-4B.

FIG. 5 is a schematic shadow side view of a radiating element with feed stalk printed circuit boards according to further embodiments of the present invention.

FIG. 6 is a schematic shadow side view of a radiating element with feed stalk printed circuit boards according to additional embodiments of the present invention.

FIGS. 7A-7C are schematic shadow plan views of feed stalk printed circuit boards according to further embodiments of the present invention.

FIGS. 8A and 8B are schematic perspective views of cloaked coaxial cables according to embodiments of the present invention.

FIG. 9A is a schematic diagram illustrating how a wide microstrip trace has a high-pass filter response.

FIG. 9B is a schematic diagram illustrating how a narrower microstrip trace has a high-pass filter response that is offset to lower frequencies as compared to the wide microstrip trace of FIG. 9A.

FIG. 9C is a schematic diagram illustrating how a narrow microstrip trace with co-planar waveguide like stubs has a band-pass filter response.

FIG. 10A is a schematic shadow side view of the feed stalk of a radiating element according to further embodiments of the present invention.

FIG. 10B is a schematic shadow perspective view of a cloaked portion of a ground line included on one of the feed stalk printed circuit boards of the feed stalk of FIG. 10A.

FIG. 10C is a schematic cross-sectional view taken along line 10C-10C of FIG. 10B.

FIG. 10D is a schematic shadow perspective view of another cloaked portion of the ground line included on one of the feed stalk printed circuit boards of the feed stalk of FIG. 10A.

FIG. 10E is a schematic cross-sectional view taken along line 10E-10E of FIG. 10D.

FIG. 11 is a schematic side view of the feed stalk of a radiating element according to still further embodiments of the present invention.

FIG. 12A is a schematic shadow side view of a mid-band radiating element according to additional embodiments of the present invention.

FIG. 12B is a schematic shadow side view of a mid-band radiating element according to further embodiments of the present invention.

FIG. 13 is a schematic perspective view of a cloaked coaxial cable according to further embodiments of the present invention.

### DETAILED DESCRIPTION

The above-described passive/active antenna systems allow a cellular operator to support both legacy 2G/3G/4G cellular service and 5G cellular service using a single base station antenna system. Unfortunately, however, in practice the radiating elements of the passive 2G/3G/4G arrays that are mounted in front of the 5G beamforming array can cause “scattering” of the antenna beams generated by the 5G beamforming array. Scattering is undesirable as it may reduce the gain of the 5G antenna beams by changing the shape thereof in both the azimuth and elevation planes. For example, scattering tends to negatively impact the beamwidth, beam shape, pointing angle, gain and front-to-back ratio of the 5G antenna beams.

Two different types of scattering can occur. First, conductive structures of the radiating elements of the lower frequency (passive) arrays that are mounted in front of the 5G beamforming array can reflect RF energy transmitted by the radiating elements of the beamforming array. Some of this reflected RF energy may then exit the base station antenna in undesired directions (potentially after further reflecting off of other metal structures in the base station antenna such as the reflector, etc.) or may exit the base station antenna in a desired direction but with phases that cause the reflected RF energy to destructively combine with non-reflected RF energy. The net result is that when RF energy emitted by the beamforming array reflects off the radiating elements of the passive 2G/3G/4G linear arrays, these reflections generally act to distort the radiation pattern generated by the beamforming array in undesirable ways.

The second type of scattering occurs when a conductive structure of the radiating elements of the passive 2G/3G/4G linear arrays has an electrical length that makes the structure resonant in the operating frequency band of the 5G beamforming array. A conductive structure of a radiating element of one of the passive (lower frequency band) arrays may be resonant in the operating frequency band of the 5G (higher frequency band) beamforming array if, for example, the conductive structure has an electrical length that is about ½ a wavelength or about a full wavelength of a frequency within the operating frequency band of the 5G beamforming array. In many cases, the operating frequency band of the beamforming array may be about four times frequencies within the operating frequency band of the passive low-band linear arrays and about twice frequencies within the operating frequency band of the passive mid-band linear arrays. Since, for example, the dipole arms of the radiating elements of the low-band linear arrays typically have an electrical length of about ¼ of a center wavelength of the low-band operating frequency range, they may have a resonant length with respect to RF energy emitted by the 5G beamforming array. As such, RF energy transmitted by the 5G beamforming array may couple to, for example, the dipole arms of nearby low-band radiating elements, and the higher-band currents formed on these dipole arms generates additional high-band radiation that distorts the high-band antenna beams (since some of the RF energy is being emitted from unintended locations, namely from the low-band dipole arms).

So-called “cloaking” radiating elements are known in the art that have dipole arms that are designed so that currents will largely not form thereon in response to RF radiation in pre-selected frequency ranges (e.g., currents in the operating frequency band of the high-band radiating elements in the 5G beamforming array). These radiating elements can reduce or eliminate the second of the above-described types of scattering of higher frequency band radiation by the dipole arms of nearby lower frequency band radiating elements. The present invention is based, in part, on the realization that the feed stalks of the lower frequency band radiating elements (e.g., the low-band and/or mid-band radiating elements) may also cause both of the above-describe types of scattering. A feed stalk of a cross-dipole radiating element refers to a structure that feeds RF signals to and from the dipole arms of the radiating element. In most cases, the dipole arms are mounted on the distal (forward) end of the feed stalk, and the base (rear) end of the feed stalk is mounted on the reflector of the base station antenna or on a feed board printed circuit board that is mounted on the reflector.

The feed stalks of the low-band radiating elements may include a number of metal patterns that can reflect high-band RF radiation emitted by a high-band beamforming array that is mounted behind the low-band radiating elements (i.e., the feed stalks of the low-band radiating elements can cause the first type of scattering discussed above). Such reflections can degrade the shape and characteristics of the antenna beams formed by the high-band 5G beamforming array. In addition, the feed stalks of the low-band band radiating elements also typically have metal structures that have lengths that are about ¼ of the center wavelength of the low-band operating frequency range, and hence the feed stalks of the low-band radiating elements may also cause the second type of scattering discussed above with respect to RF radiation emitted by the 5G beamforming array. While the amount of scattering caused by the feed stalks tends to be much lower than the scattering caused by non-cloaked low-band dipole arms, the amount of scattering may still be significant enough to distort the antenna beams formed by the 5G beamforming array.

Pursuant to embodiments of the present invention, base station antennas are provided that include low-band (or mid-band) radiating elements that have cloaked feed stalks that may have reduced impact on high-band RF radiation emitted by a high-band array that is positioned beside and/or rearwardly of the low-band radiating elements. In some embodiments, the radiating elements have feed stalks that include metamaterial structures such as split ring resonators or complementary split ring resonators. The metamaterial structures may be designed to cancel currents in the operating frequency band(s) of the nearby higher-band radiating elements. As such, the metamaterial structures may make the feed stalk more transparent to RF energy in one or more frequency ranges, such as the operating frequency range of the above-discussed high-band beamforming array that is mounted behind the low-band radiating elements. In some embodiments, the metamaterial structures on the feed stalks of the low-band radiating elements may have a bandpass filter response where they substantially pass RF energy in the operating frequency range of the above-discussed high-band array. The metamaterial structures may, for example, overlap elements of the twin ground lines of the microstrip feed lines on the feed stalk in order to cloak the twin ground lines. These metamaterial structures may, for example, render portions of the metal structures on the feed stalk more transparent to the high-band RF radiation emitted by the above-discussed high-band array that is positioned rearwardly of the low-band radiating elements. Since scattering tends to occur when metal structures on the feed stalk have lengths that are resonant within the operating frequency band of the high-band array, what may be important is ensuring that the feed stalk does not include metal structures having a length that is a quarter wavelength multiple of frequencies within the operating frequency band of the high-band array. Thus, it may not be necessary to completely cover the metal structures on the feed stalk using metamaterial structures; instead it may be enough to cover portions so that the exposed metal structures are not resonant within the operating frequency band of the high-band array.

According to further embodiments of the present invention, radiating elements are provided that have feed stalks with RF feed lines that include filter-based cloaking circuits. While resonant circuits are sometimes included on feed stalks of radiating elements for base station antennas, these resonant circuits (e.g., capacitors or series inductor-capacitor circuits) are typically provided for impedance matching the dipole arms of the radiating element to the RF transmission lines on the feed stalk. For example, U.S. Pat. No. 9,819,084 discloses using capacitor-inductor-capacitor impedance matching circuits that may be implemented on the feed stalk and/or in the connection between the feed stalk and the dipole arms to provide improved impedance matching. Pursuant to embodiments of the present invention, filter-based cloaking structures may be formed in the metal structures on the feed stalk. These filters may be tuned to pass RF energy in the operating frequency band of the radiating element while rejecting (blocking) RF energy in the operating frequency band of other nearby radiating elements that operate in different frequency bands.

Pursuant to further embodiments of the present invention, lower-band radiating elements are provided that have feed stalks that include one or more ground lines. At least one of the ground lines may be made to be relatively narrow to provide an increased inductance. Short metal stubs may be provided on one or both sides of the narrow ground line that introduce capacitances that are in parallel to the inductance of the ground line to form an inductor-capacitor (L-C) circuit that has band pass filter properties. The inductance value can be adjusted by, for example, adjusting the length and/or width of the ground line, and the capacitance values can be selected by adjusting the length of the metal stubs and/or the distances between the ground line and the metal stubs. By adjusting the inductance and/or capacitance values, the location of the pass band of the band pass filter may be adjusted so that the pass band falls within the operating frequency band of nearby higher-band radiating elements. The net effect is that the addition of the short metal stubs act to cloak the ground line on the lower-band radiating element to RF energy in the operating frequency band of the nearby higher-band radiating elements.

The feed stalk of the lower-band radiating element may comprise one or more feed stalk printed circuit boards that have a first metallization layer that includes the ground lines (or at least portions of the ground lines) and a second metallization layer that includes the signal line (or at least a portion thereof). In some embodiments, the feed stalk printed circuit board may include a plurality of sections where metal stubs are provided on one or both sides of the ground line. Each of these sections may be viewed as a unit cell of a frequency selective surface. Additional metal stubs may be provided on the opposed side of the feed stalk printed circuit board that may overlap the metal stubs that are provided on one or both sides of the ground line. The overlapping metal stubs and the additional metal stubs may be galvanically connected to each other through, for example, plated through holes in the feed stalk printed circuit board.

In still other embodiments of the present invention, cloaked coaxial cables are provided that may have increased transparency to RF energy in selected frequency bands. These cloaked coaxial cables may, for example, have metamaterial structures printed on the outer protective jackets of the cable. These metamaterial structures may be designed to make the coaxial cables more transparent to RF energy in one or more frequency ranges, thereby decreasing the extent to which the coaxial cables scatter RF energy in these frequency ranges. The metamaterial structures may comprise, for example, split ring resonators or complementary split ring resonators. In other embodiments, short metal sleeve sections may be provided on the coaxial cable that are designed to have a band pass filter response that cloaks the coaxial cable in a pre-determined frequency range.

Before discussing the radiating elements according to embodiments of the present invention it is helpful to discuss the design and operation of a representative conventional low-band radiating element for a base station antenna, as well as a base station antenna in which the radiating elements and coaxial cables according to embodiments of the present invention may be used.

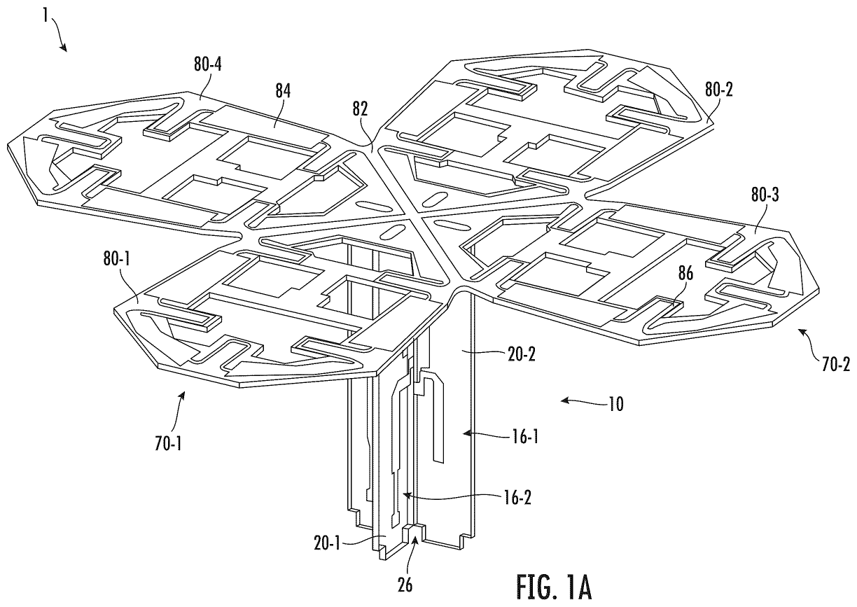

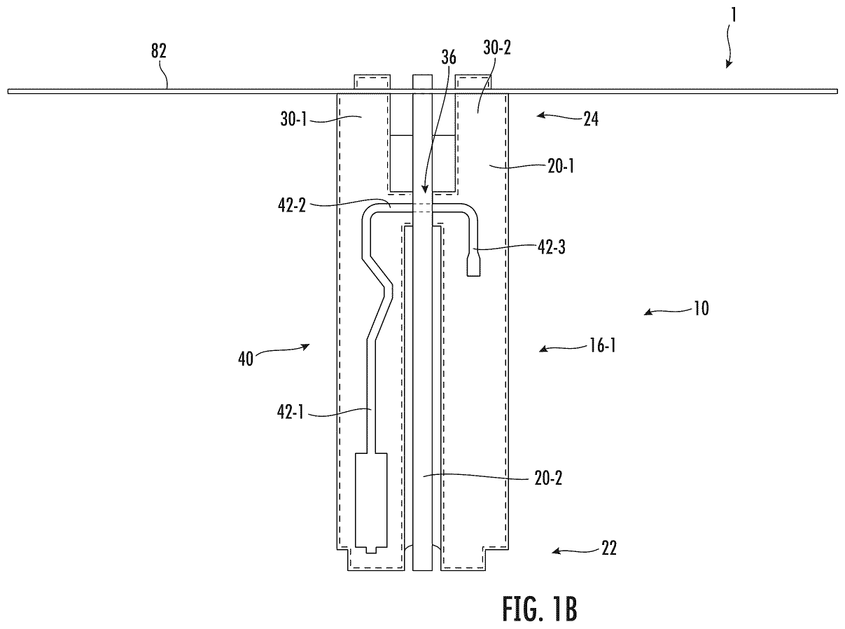

FIG. 1A is a perspective view of a conventional low-band cross-dipole radiating element 1. FIG. 1B is a shadow side view of cross-dipole radiating element 1 that illustrates the metallization patterns on a first feed stalk printed circuit board 20-1 of radiating element 1. In FIG. 1B, the solid lines are the metallization patterns on a first side of feed stalk printed circuit board 20-1 and the dashed lines are the metallization patterns on a second (opposed) side of feed stalk printed circuit board 20-1. In FIG. 1B, only a side surface of a second feed stalk printed circuit board 20-2 is visible as the major surfaces of feed stalk printed circuit board 20-2 are perpendicular to the viewing angle. It should be noted that herein like elements may be referred to individually by their full reference numeral (e.g., feed stalk printed circuit board 20-2) and may be referred to collectively by the first part of their reference numeral (e.g., the feed stalk printed circuit boards 20).

As shown in FIG. 1A, the conventional cross-dipole radiating element 1 includes a feed stalk 10 and a pair of dipole radiators 70-1, 70-2. The feed stalk 10 comprises first and second feed stalk printed circuit boards 20-1, 20-2. Each feed stalk printed circuit board 20-1, 20-2 includes a respective RF feed line 16-1, 16-2. The RF feed lines 16-1, 16-2 carry RF signals between first and second RF transmission lines (not shown) that connect to the radiating element 1 to pass RF signals to and from the radiating element 1. Each such RF transmission line may comprise, for example, a coaxial cable or a microstrip transmission line on a feed board printed circuit board.

Referring to both FIGS. 1A and 1B, each feed stalk printed circuit board 20 has a base 22 and a distal end 24 that is positioned forwardly of the base 22. The first feed stalk printed circuit board 20-1 includes a slit 26 that extends forwardly from the base 22 thereof, and the second feed stalk printed circuit board 20-2 includes a slit 26 that extends rearwardly from the distal end 24 thereof. Feed stalk printed circuit boards 20-1 and 20-2 are arranged perpendicular to each other with the slits 26 thereof engaged so that the two mated feed stalk printed circuit boards 20-1, 20-2 have a cross-shape when viewed from the front.

Rear portions of each feed stalk printed circuit board 20 may include projections that are inserted through slits in a feed board printed circuit board (not shown). Metallized pads on the projections may be soldered to metallized pads on the feed board printed circuit board to mechanically mount the radiating element 1 on the feed board printed circuit board and to electrically connect the RF feed lines 16-1, 16-2 on the feed stalk 10 to the RF transmission lines on the feed board printed circuit board.

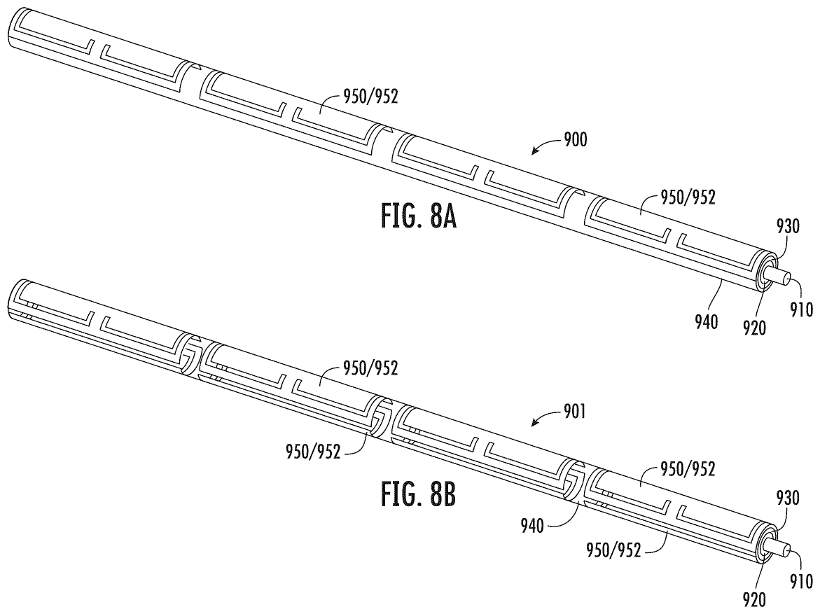

The dipole radiators 70-1, 70-2 are positioned at the distal ends 24 of the feed stalk printed circuit boards 20 and may be (and typically are) physically mounted on the feed stalk printed circuit boards 20. The first dipole radiator 70-1 extends along a first axis and the second dipole radiator 70-2 extends along a second axis that is generally perpendicular to the first axis. The first dipole radiator 70-1 includes first and second dipole arms 80-1, 80-2, and the second dipole radiator 70-2 includes third and fourth dipole arms 80-3, 80-4. The dipole radiators 70-1, 70-2 may be formed in a dipole radiator printed circuit board 82. The dipole arms 80 are cloaking dipole arms that are formed as a series of widened metal segments 84 that are interconnected by narrow metal traces 86 (see FIG. 1A). As shown, the narrow metal traces 86 may be “meandered” traces that have U-shapes (or other meandered shapes) so that the traces may have a relatively long length while being fit into small spaces between adjacent widened metal segments 84. The average width of each widened metal segment 84 may be at least three times, or at least four times, or at least five times the average width of each narrow metal trace 86. The dipole radiators 70-1, 70-2 are shown as having an elongated “FIG. 8” shape where each dipole arm 80 is formed as a loop. A wide variety of dipole arms are known in the art, including dipole arms that have many different shapes or that are formed in different ways (e.g., using sheet metal). It will be appreciated that the radiating elements according to embodiments of the present invention that have the feed stalk designs disclosed herein may have any appropriate dipole arm design.

Dipole arms 80-1 and 80-2 of first dipole radiator 70-1 are center fed by the first RF feed line 16-1 on the first feed stalk printed circuit board 20-1 and radiate together at a first polarization. In the depicted embodiment, the first dipole radiator 70-1 is designed to transmit and receive signals having a slant +45° linear polarization. Dipole arms 80-3 and 80-4 of second dipole radiator 70-2 are center fed by the second RF feed line 16-2 on the second feed stalk printed circuit board 20-2 and radiate together at a second polarization that is orthogonal to the first polarization. The second dipole radiator 70-2 is designed to transmit and receive signals having a slant −45° linear polarization.

As shown in FIG. 1B, a twin line transmission line structure is formed on the second side of feed stalk printed circuit board 20-1. The twin line transmission line structure comprises first and second ground lines 30-1, 30-2 that are implemented as first and second metallized regions that extend from the base 22 of the first feed stalk printed circuit board 20-1 to the distal end 24 thereof. Each ground line 30-1, 30-2 is coupled to the ground conductor of the first RF transmission line that feeds radiating element 1 (not shown). The connections between the first and second ground lines 30-1, 30-2 and the ground conductor of the first RF transmission line may be at the base 22 of the first feed stalk printed circuit board 20-1. The first and second ground lines 30-1, 30-2 may each have an electrical length of about ¼ the center wavelength of radiating element 1.

A signal line 40 is formed on the first side of feed stalk printed circuit board 20-1. The signal line 40 is coupled to the signal conductor of the RF transmission line that feeds the first feed stalk printed circuit board 20-1. The signal line 40 extends forwardly from the base 22 of the first feed stalk printed circuit board 20-1 and travels about two-thirds of the way toward the distal end 24 thereof. The signal line 40 then goes through a first 90° turn to extend transversely across the first side of feed stalk printed circuit board 20-1. Finally, the signal line 40 goes through a second 90° turn to extend rearwardly toward the base 22 of the first feed stalk printed circuit board 20-1.

The signal line 40 includes a forwardly extending segment 42-1, a transversely extending segment 42-2, and a rearwardly extending segment 42-3. The forwardly extending segment 42-1 overlaps the first ground line 30-1. Herein, two elements on a printed circuit board (or an equivalent structure) “overlap” if an axis that is perpendicular to a major surface of the printed circuit board intersects both elements. The transversely extending segment 42-2 extends from the end of the forwardly extending segment 42-1, to cross over a gap 36 (i.e., an unmetallized region) that is provided between the first and second ground lines 30-1, 30-2. The transversely extending segment 42-2 overlaps portions of both the first ground line 30-1 and the second ground line 30-2. The rearwardly extending segment 42-3 extends at a right angle from the end of the transversely extending segment 42-2 back toward the base 22 of the first feed stalk printed circuit board 20-1. The rearwardly extending segment 42-3 overlaps the second ground line 30-2.

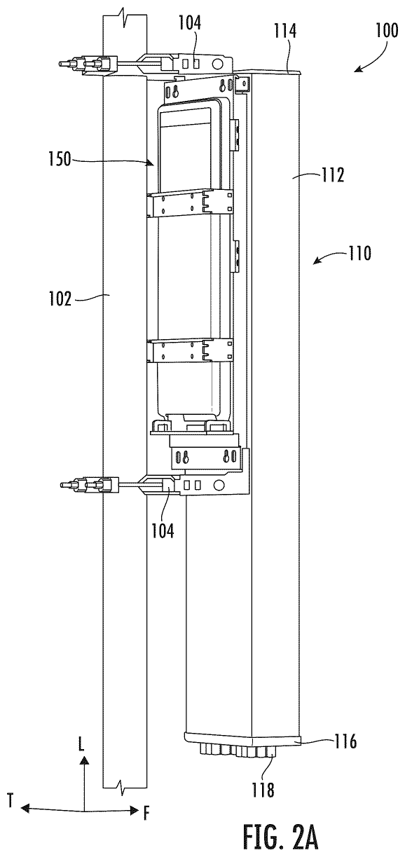

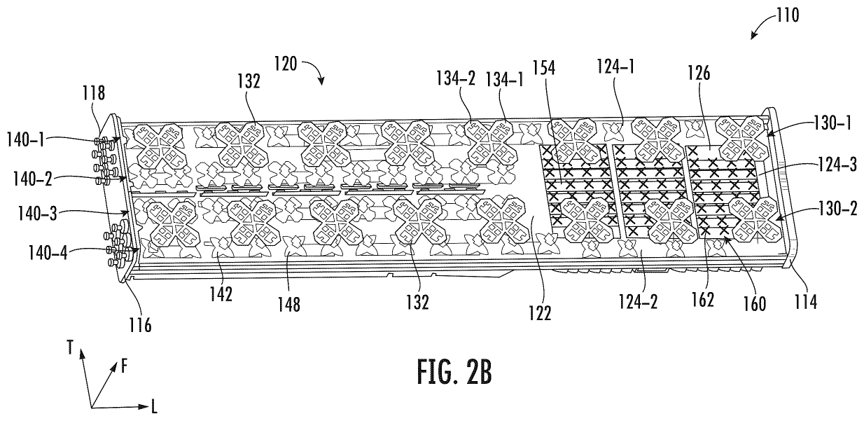

FIGS. 2A-2B illustrate a conventional passive/active antenna system 100 that includes both a passive base station antenna 110 and an active antenna module 150. In particular, FIG. 2A is a schematic rear perspective view of the passive/active antenna system 100, while FIG. 2B is a schematic perspective view of the passive/active antenna system 100 of FIG. 2A with radomes of both the passive base station antenna 110 and the active antenna module omitted. In FIGS. 2A and 2B, the axes illustrate the longitudinal (L), transverse (T) and forward (F) directions of the base station antenna system 100. In the description that follows, the antenna 100 and the radiating elements included therein will be described using terms that assume that the antenna 100 is mounted for normal use on a tower with a longitudinal axis of the antenna 100 extending along a vertical axis and the front surface of the antenna 100 mounted opposite the tower pointing toward the coverage area for the antenna 100.

Referring to FIG. 2A, the passive/active antenna system 100 may be mounted, for example, on an antenna tower 102 using mounting hardware 104. The active antenna module 150 may be mounted directly on a rear surface of the passive base station antenna 110, or may be held in place behind the passive base station antenna 110 by the mounting hardware 104. The front surface of the passive/active antenna system 100 may be opposite the antenna tower 102 facing toward a coverage area of the passive/active antenna system 100. The passive base station antenna 110 includes a tubular radome 112 that surrounds and protects an antenna assembly that is mounted inside the radome 112. A top end cap 114 covers a top opening in the radome 112 and a bottom end cap 116 covers a bottom opening in the radome 112. A plurality of RF ports 118 extend through the bottom end cap 116 and are used to connect the passive base station antenna 110 to one or more external radios (not shown). The active antenna module 150 may be removably mounted behind the passive base station antenna 110 so that the active antenna module 150 may later be replaced with a different active antenna module.

Referring to FIG. 2B, the passive base station antenna 110 includes a reflector assembly 120. The reflector assembly 120 may be referred to herein as a “passive reflector assembly” since it is part of the passive base station antenna 110. The passive reflector assembly 120 includes a main reflector 122 and spaced-apart first and second reflector strips 124-1, 124-2 that extend longitudinally from respective first and second opposed sides of the main reflector 122. The passive reflector assembly 120 may further include a third reflector strip 124-3 that extends in a transverse direction between top ends of the first and second reflector strips 124-1, 124-2. An opening 126 is defined between the first and second reflector strips 124-1, 124-2. For example, the opening 126 may be bounded by a top portion of the main reflector 122, the first and second reflector strips 124-1, 124-2, and the third reflector strip 124-3. At least the main reflector 122 may comprise a metallic surface (e.g., a sheet of aluminium) that serves as a reflector and ground plane for the radiating elements of the antenna 100. Various mechanical and electronic components of the antenna (not shown) may be mounted behind the passive reflector assembly 120 such as, for example, phase shifters, remote electronic tilt units, mechanical linkages, controllers, diplexers, and the like.

The passive base station antenna 110 further includes a plurality of passive linear arrays of radiating elements that extend forwardly from the passive reflector assembly 120. The linear arrays may support, for example, 2G, 3G and/or 4G cellular service. In the example passive base station antenna 110 shown in FIGS. 2A-2B, the linear arrays include first and second low-band linear arrays 130-1, 130-2 that are configured to operate in all or part of the 617-960 MHz frequency band. Each low-band linear array 130 comprises a vertically-extending column of low-band radiating elements 132. The passive base station antenna 110 further includes first through fourth mid-band linear arrays 140-1 through 140-4 that are configured to operate in all or part of the 1427-2690 MHz frequency band. Each mid-band linear array 140 comprises a vertically-extending column of mid-band radiating elements 142. Each of the low-band and mid-band linear arrays 130, 140 may generate static antenna beams that provide coverage to a predefined coverage area (e.g., antenna beams that are each configured to cover a sector of a base station), with the only change to the coverage area occurring when the electronic downtilt angles of the generated antenna beams are adjusted (e.g., to change the size of the sector served by the passive base station antenna 110).

Each of the low-band and mid-band radiating elements 132, 142 may be implemented as dual-polarized radiating elements that include first and second radiators that transmit and receive RF energy at orthogonal polarizations. When such dual-polarized radiating elements are used, each of the low-band and mid-band linear arrays 130, 140 may be connected to a pair of the RF ports 118. The first RF port 118 is connected between a first port of a radio (e.g., a remote radio head mounted on the antenna tower 102 near the passive base station antenna 110) and the first polarization radiators of the radiating elements in one of the linear arrays, and the second RF port 118 is connected between a second port of a radio and the second polarization radiators of the radiating elements in the linear array. RF signals that are to be transmitted by a selected one of the linear arrays 130, 140 are passed from the radio(s) to one of the RF ports 118, and passed from the RF port 118 to a power divider (or, alternatively, a phase shifter assembly that includes a power divider) that divides the RF signal into a plurality of sub-components that are fed to the respective first or second radiators of the radiating elements in the linear array, where the sub-components of the RF signal are radiated into free space.

The low-band and/or mid-band radiating elements 132, 142 may be mounted on feed board printed circuit boards that couple RF signals to and from the individual radiating elements 132, 142. In FIG. 2B, the mid-band radiating elements 142 are shown as being mounted in pairs on a plurality of mid-band feed board printed circuit boards 148 (the low-band radiating elements are likewise mounted on feed board printed circuit boards but they are not visible in the figure). Cables may be used to connect each feed board printed circuit board 148 to other components of the antenna such as diplexers, phase shifters or the like.

Most of the low-band and mid-band radiating elements 132, 142 are mounted to extend forwardly from the main reflector 122. However, low-band linear arrays 130-1, 130-2 extend substantially the full length of the passive/active antenna system 100 and hence extend beyond the main reflector 122. The first and second reflector strips 124-1, 124-2 may provide mounting locations for low-band radiating elements 132 that are positioned above the main reflector 122. The first and second reflector strips 124-1, 124-2 may be integral with the main reflector 122 so that the first and second reflector strips 124-1, 124-2 and the main reflector 122 will be maintained at a common ground voltage, which may improve the performance of the low-band linear arrays 130-1, 130-2.

Each low-band radiating element 132 may comprise a slant −45°/+45° cross-dipole radiating element that includes a slant −45° polarization dipole radiator 134-1 and a slant +45° polarization dipole radiator 134-2. The dipole radiators 134-1, 134-2 may be mounted on a feed stalk (not shown). In some cases, the three uppermost low-band radiating elements 132 may be mounted on a frequency selective surface (not shown) that covers the opening 126. This frequency selective surface is described in further detail below. In other cases, the low-band radiating elements 132 may include tilted feed stalks that allow these radiating elements to be mounted on the first and second reflector strips 124-1, 124-2 while the dipole radiators 134 of these radiating elements 132 are in front of the opening 126 (and any FSS covers the opening 126). Each low-band radiating element 132 has dipole radiators 134 that are designed to be substantially transparent to RF energy emitted by the mid-band radiating elements 142.

The active antenna module 150 includes a multi-column beamforming array 160 of high-band radiating elements 162 and a beamforming radio (not visible in the figures). The multi-column beamforming array 160 may be mounted in a forward portion of the active antenna module 150, and the beamforming radio may be mounted behind the multi-column beamforming array 160. The beamforming array 160 may, for example, comprise a plurality of vertically-extending columns of high-band radiating elements 162 that are configured to operate in all or part of the 3.1-4.2 GHz frequency band (e.g., in the 3.1-3.6 GHz frequency band). The high-band radiating elements 162 are mounted to extend forwardly from a reflector 154 of the active antenna module 150 (herein the “active reflector”). The beamforming radio is capable of electronically adjusting the amplitude and/or phase of the subcomponents of an RF signal that are output to different radiating elements 162 of the multi-column beamforming array 160. For example, each port of the beamforming radio may be coupled to a column of high-band radiating elements 162 of the beamforming array 160, and the amplitudes and phases of the sub-components of the RF signals that are fed to each column may be adjusted so that the generated antenna beams are narrowed in the azimuth plane and pointed in a desired direction in the azimuth plane.

The beamforming array 160 of active antenna module 150 is mounted behind the opening 126 in the passive reflector assembly 120. The beamforming array 160 is visible in FIG. 2B as the frequency selective surface and the radome of the passive base station antenna 110 are omitted in FIG. 2B, as is the radome of the active antenna module 150. The opening 126 in the passive reflector assembly 120 (and any frequency selective surface that extends across the opening 126) allows the antenna beams generated by the beamforming array 160 to pass through the passive base station antenna 110 to provide service to the coverage area of the passive/active antenna system 100.

As discussed above, a frequency selective surface (not shown) may cover the opening 126. The frequency selective surface may be configured to allow RF energy emitted by the high band radiating elements 162 in the beamforming array 160 to pass therethrough, while the frequency selective surface reflects RF energy in lower frequency bands (and specifically, low-band RF signals that are emitted by the low-band radiating elements 132). The frequency selective surface may be coplanar with the opening 126, in front of the opening 126 or behind the opening 126. The frequency selective surface can have a grid pattern such as a grid of metal pads and/or other metal structures. The grid pattern can be arranged in any suitable manner and may be symmetric or asymmetric across a width and/or length of the frequency selective surface. The grid pattern may comprise sub-wavelength periodic microstructures. The metal pads/structures may be arranged in one or more layers. The frequency selective surface may be formed on a substrate such as, for example, a printed circuit board or of stamped sheet metal in example embodiments. In some embodiments, the frequency selective surface may comprise a portion of the passive reflector assembly 120 that is stamped to form the metal grid structure therein. In such cases, the “opening” 126 comprises a large number of small openings that act as a large opening with respect to RF energy in the operating frequency band of the beamforming array 160.

One difficulty with the passive/active base station antenna system 100 of FIGS. 2A-2B is that some of the low-band radiating elements 132 are mounted directly in front of the high-band beamforming array 160. As such, metal elements of the low-band radiating elements 132 may partially block/reflect the RF radiation emitted by the high-band beamforming array 160 and/or the high-band RF radiation may induce current on metal elements of the low-band radiating elements 132 that then reradiate the high-band radiation in ways that act to distort the shape of the antenna beams generated by the high-band beamforming array 160.

As discussed above, pursuant to embodiments of the present invention, cross-dipole radiating elements are provided that have feed stalks that may be at least partially transparent to RF energy in the operating frequency bands of one or more nearby higher frequency band radiating elements. In particular, the radiating elements according to embodiments of the present invention may include metamaterial structures and/or filters that are at least partially transparent in the operating frequency bands of the nearby higher frequency band radiating elements. As such, the feed stalks of the radiating elements according to embodiments of the present invention may cause less scattering of the RF energy emitted by the nearby higher frequency band radiating elements, which may improve the peak directivity and shape of the antenna beams generated by the nearby array of higher-band radiating elements.

The discussion of the cross-dipole radiating elements according to embodiments of the present invention below will focus on low-band radiating elements that have feed stalks that are partially transparent with respect to RF radiation emitted by nearby high-band radiating elements as an example. However, it will be appreciated that the techniques disclosed herein may be used, for example, to provide mid-band radiating elements that are partially transparent with respect to RF radiation emitted by nearby high-band radiating elements or in any other appropriate application. Thus, while the radiating elements according to embodiments of the present invention are described below as being low-band radiating elements, it will be appreciated that they may alternatively be reduced in size to operate as, for example, mid-band radiating elements.

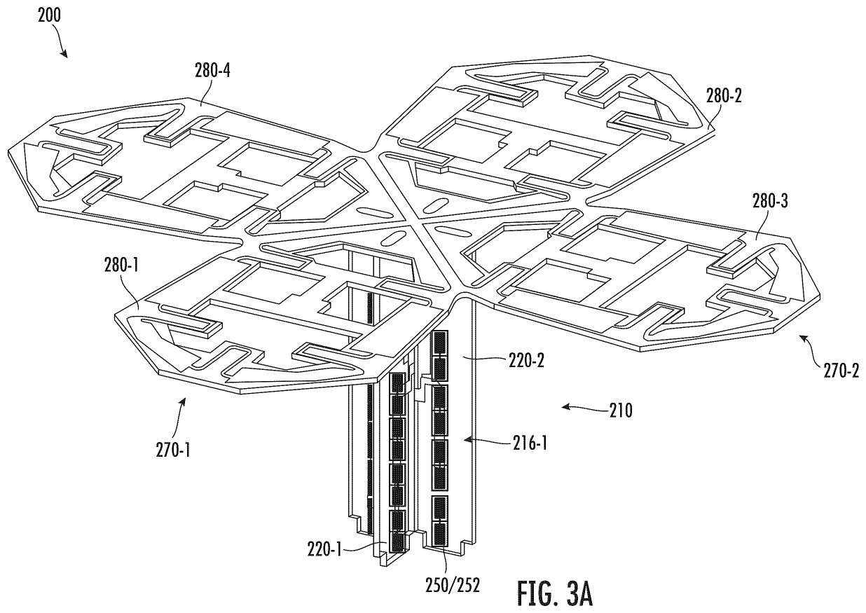

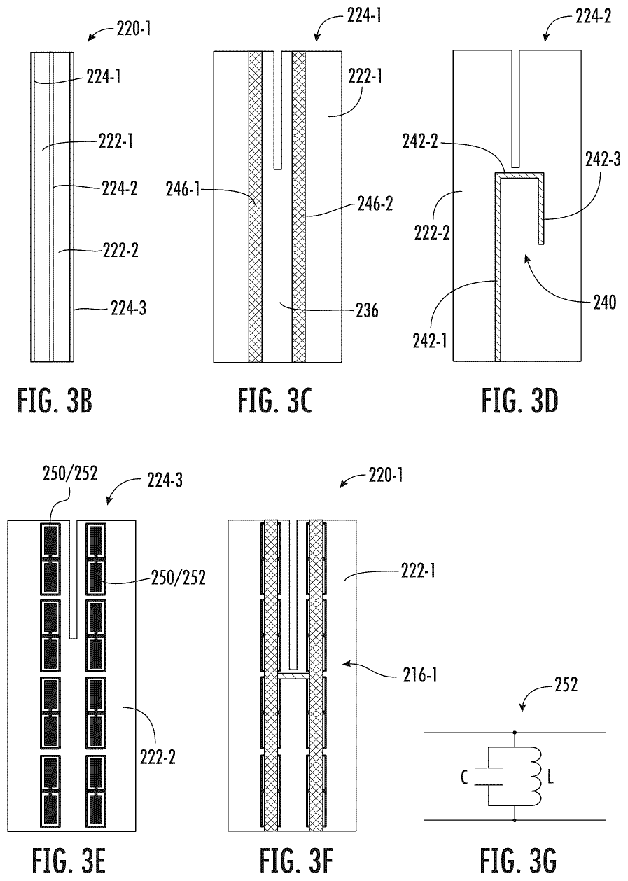

FIG. 3A is a schematic perspective view of a radiating element 200 according to embodiments of the present invention. FIG. 3B is a schematic side view of one of the feed stalk printed circuit boards included in the radiating element of FIG. 3A. FIG. 3C is a plan view of a first outer surface of the feed stalk printed circuit board of FIG. 3A. FIG. 3D is a schematic plan view of an interior metal layer of the feed stalk printed circuit board of FIG. 3B. FIG. 3E is a schematic plan view of a second outer surface of the feed stalk printed circuit board of FIG. 3B. FIG. 3F is a schematic shadow plan view of the feed stalk printed circuit board of FIGS. 3B-3E that illustrates all three metallization layers thereof.

Referring to FIG. 3A, the radiating element 200 includes a feed stalk 210, a first dipole radiator 270-1, and a second dipole radiator 270-2. The dipole radiators 270-1, 270-2 are mounted adjacent (and typically on) the distal end of the feed stalk 210. The first dipole radiator 270-1 includes first and second dipole arms 280-1, 280-2, and the second dipole radiator 270-2 includes third and fourth dipole arms 280-3, 280-4. The dipole radiators 270 and dipole arms 280 may be identical to the dipole radiators 70 and dipole arms 80 described above with reference to FIGS. 1A-1B, and hence further description thereof will be omitted here.

The feed stalk 210 comprises first and second feed stalk printed circuit boards 220-1, 220-2. Each feed stalk printed circuit board 220 has a base and a distal (forward) end that is positioned forwardly of the base. The dipole radiators 270 are mounted at the distal ends of the feed stalk printed circuit boards 220. The first feed stalk printed circuit board 220-1 includes a slit (see FIG. 3B) that extends rearwardly from the distal end thereof, and the second feed stalk printed circuit board 220-2 includes a slit that extends forwardly from the base thereof. Feed stalk printed circuit boards 220-1 and 220-2 are arranged perpendicular to each other with the slits in the two feed stalk printed circuit boards 220 received within each other so that the two mated printed circuit boards 220-1, 220-2 have a cross-shape when viewed from the front.

As shown in FIG. 3B, the first feed stalk printed circuit board 220-1 may be implemented using a multilayer printed circuit board that includes first and second dielectric substrates 222-1, 222-2 that are stacked together. First and third metallization patterns 224-1, 224-3 are provided on the respective outer major surfaces of the first and second dielectric substrates 222-1, 222-2, and a second metallization pattern 224-2 is provided in between the first and second dielectric substrates 222-1, 222-2.

FIGS. 3C-3E are plan views that illustrate each of the respective first through third metallization patterns 224-1 through 224-3 of the first feed stalk printed circuit board 220-1 (here it is assumed that the second metallization pattern 224-2 is formed on the second dielectric substrate 222-2). FIG. 3F is a shadow plan view of the first feed stalk printed circuit board 220-1 that shows the relative positions of the metal structures of all three of the first through third metallization patterns 224-1 through 224-3.

As shown in FIG. 3C, the first metallization pattern 224-1 is formed on the outer surface of the first dielectric substrate 222-1. The first metallization pattern 224-1 comprises a twin line transmission line structure that comprises first and second metal ground lines 246-1, 246-2 that extend from a base of the first feed stalk printed circuit board 220-1 to a distal end thereof. Each ground line 246-1, 246-2 is coupled to the ground conductor of the first RF transmission line that feeds radiating element 200 (not shown) at or near the base of the first feed stalk printed circuit board 220-1. The first and second ground lines 246-1, 246-2 may each have an electrical length of about ¼ the center wavelength of radiating element 200.

As shown in FIG. 3D, the second metallization pattern 224-2 is formed on the inner surface of either (or both) the first dielectric substrate 222-1 and/or the second dielectric substrate 222-2. The second metallization pattern 224-2 comprises a signal line 240 that is coupled to the signal conductor of the RF transmission line that feeds the first feed stalk printed circuit board 220-1. The signal line 240 extends forwardly from the base of the first feed stalk printed circuit board 220-1 and travels about two-thirds of the way toward the distal end thereof. The signal line 240 then goes through a first 90° turn to extend transversely across the first side of feed stalk printed circuit board 220-1. Finally, the signal line 240 goes through a second 90° turn to extend rearwardly toward the base of the first feed stalk printed circuit board 220-1.

The signal line 240 includes a forwardly extending segment 242-1, a transversely extending segment 242-2, and a rearwardly extending segment 242-3. The forwardly extending segment 242-1 overlaps the first ground line 246-1 (see FIG. 3F). Herein, two elements on a printed circuit board (or an equivalent structure) “overlap” if an axis that is perpendicular to a major surface of the printed circuit board intersects both elements. The transversely extending segment 242-2 extends from the end of the forwardly extending segment 242-1, to cross over a gap 236 (i.e., an unmetallized region) that is provided between the first and second ground lines 246-1, 246-2 (see FIG. 3C). The transversely extending segment 242-2 overlaps portions of both the first ground line 246-1 and the second ground line 246-2. The rearwardly extending segment 242-3 extends at a right angle from the end of the transversely extending segment 242-2 back toward the base of the first feed stalk printed circuit board 220-1. The rearwardly extending segment 242-3 overlaps the second ground line 246-2.

The signal trace 240 and the first and second ground lines 246-1, 246-2 together form an RF feed line 216-1 (see FIG. 3F) that carries RF signals between an RF transmission line (not shown) of the feed network for radiating element 200 and the cross-dipole radiator 270-1. The RF transmission line of the feed network may comprise, for example, a coaxial cable or a microstrip transmission line on a feed board printed circuit board. The RF feed line 216-1 carries RF signals between the cross-dipole radiator 270-1 and other components of a base station antenna that includes radiating element 200.

As shown in FIG. 3E, the third metallization pattern 224-3 is formed on the outer surface of the second dielectric substrate 222-2. The third metallization layer 224-3 comprises a pair of metamaterial structures 250. Each metamaterial structure 250 may overlap a respective one of the ground lines 246-1, 246-2. In the depicted embodiment, each metamaterial structure 250 comprises a plurality of complementary split ring resonators 252 that are arranged along axes defined by the respective ground lines 246-1, 246-2. A complementary split ring resonator is a ring-based metamaterial resonator. Another known metamaterial ring resonator is the split ring resonator. A split ring resonator consists of a pair of concentric metallic rings (also called loops), which are usually formed by etching a metal layer on a dielectric substrate (e.g., using printed circuit board fabrication techniques). Slits may be formed on opposite sides of the rings. The rings may be square, circular, oval, rectangular or any other appropriate shape. A small gap is provided between the two rings. Magnetic flux that is incident on the split ring resonator induces rotating currents in the rings, and in response to the currents, the rings produce their own flux to enhance or oppose the incident electromagnetic field (depending on the resonant properties of the split ring resonator). The small gaps between the rings produce large capacitance values which lower the resonating frequency, which allows split ring resonators to act as if they are electrically smaller (as compared to their physical size) when responding to RF energy. The equivalent circuit of a single split ring resonator is shown in FIG. 3G, where L stands for the inductive coupling and C stands for the capacitive coupling. The resonant frequency of the split ring resonator is:

$${f}_{r} = \frac{1}{2 π \sqrt{L C}}$$

A complementary split ring resonator is a complementary structure to a split ring resonator. Thus, a complementary split ring resonator may be formed by providing a metal layer and then removing the metal to form a non-metallized region having the shape of a split ring resonator. In other words, a complementary split ring resonator is the negative image of the above-described split ring resonator. Embodiments of the present invention are illustrated herein as being implemented as complementary split ring resonators, but it will be appreciated that split ring resonators or other metamaterial structures may be used in other embodiments.

As noted above, each complementary split ring resonator 252 will have a resonant frequency. As such, each complementary split ring resonator 252 may act like a band pass or band stop filter that does not pass RF energy in a frequency range centered around the resonant frequency. Within the stop band, currents that are induced on the complementary split ring resonators in response to RF energy emitted by nearby radiating elements are cancelled within the ring structures. Thus, by designing the complementary split ring resonators 252 to have resonant frequencies within the operating frequency band of nearby, higher band radiating elements, the complementary split ring resonators 252 may “hide” the twin ground lines 246-2, 246-2 from RF radiation emitted by nearby higher band radiating elements while also not being metal structures on which high-band currents will form. As a result, the complementary split ring resonators 252 act to make the feed stalk printed circuit board 220-1 more transparent to RF signals in the operating frequency band of the nearby higher band radiating elements.

In some embodiments, in order to widen the frequency range where the feed stalk printed circuit board 220-1 will be more transparent to RF signals, the resonant frequencies of the complementary split ring resonators 252 may be designed to have different resonant frequencies which may be spaced apart over the operating frequency band of the nearby higher band radiating elements. For example, if the operating frequency band of the nearby higher band radiating elements is the 3.1-3.7 GHz frequency band, the resonant frequencies for the complementary split ring resonators 252 might be selected to be at, for example, 3.15 GHZ, 3.3 GHZ, 3.45 GHz and 3.6 GHz. The resonant frequency of each complementary split ring resonator 252 may be adjusted by varying the inductance and/or the capacitance thereof. For example, the resonant frequency may be varied by changing the length of each section while keeping all other parameters constant.

FIG. 3F is a schematic shadow plan view of the first feed stalk printed circuit board 220-1 that illustrates how the various metal structures of the first through third metallization layers 224-1 through 224-3 overlap.

The second feed stalk printed circuit board 220-2 may have substantially the same design as the first feed stalk printed circuit board 220-1 except that the slit in the second feed stalk printed circuit board 220-2 extends forwardly from the base of the second feed stalk printed circuit board 220-2 instead of extending rearwardly from the distal end thereof as is the case with the slit in the first feed stalk printed circuit board 220-1, and a signal line 240 on the second feed stalk printed circuit board 220-2 extends farther forwardly before bending to form a U-shape so that the signal line 240 may extend past the slit. Thus, further description of the second feed stalk printed circuit board 220-2 will be omitted here.

By adding the metamaterial structures 250 to the first and second feed stalk printed circuit boards 220-1, 220-2, the negative impact that the feed stalk 210 of the low-band radiating element 200 may have on the antenna beams generated by the high-band beamforming array 160 may be reduced. The first and second ground lines 30-1, 30-2 that are part of the feed stalk 10 of the conventional low-band radiating element 1 each comprise a large metallized region. As such, when the passive/active antenna system 100 of FIGS. 2A-2B includes linear arrays of low-band radiating elements 1, the ground lines 20 may reflect RF radiation emitted by the high-band beamforming array 160 (i.e., may cause the first type of scattering), particularly when the high-band beamforming array 160 is electronically scanned in the azimuth plane. In addition, the first and second ground lines 30-1, 30-2 may each have a length of about ¼ of the center wavelength of radiating element 1, and hence may have a length that is about one wavelength of a frequency within the operating frequency range of the high-band beamforming array 160. As such, high-band currents may form on the ground lines 20 in response to RF radiation emitted by the high-band beamforming array 160, and the ground lines 20 may then emit high-band radiation in response to these currents, meaning that the conventional feed stalk 10 may also cause the second type of scattering discussed above. Since the low-band radiating element 200 according to embodiments of the present invention has feed stalk printed circuit boards 220 with twin ground lines 246 that are cloaked using metamaterial structures 250 with respect to RF energy in the high-band frequency range, the impact of the feed stalks 210 on the high-band antenna beams may be reduced. For example, the use of the cloaked feed stalks may improve the gain of the high-band beamforming array by 0.1 dB to 0.2 dB.

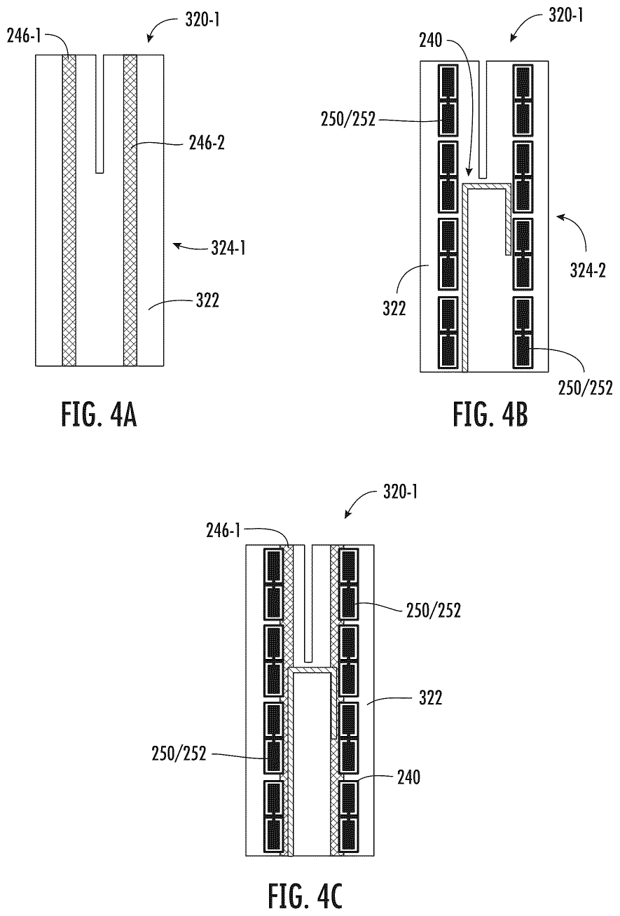

FIGS. 4A-4C are schematic views of a feed stalk printed circuit board 320-1 that may be used in place of the feed stalk printed circuit board 220-1 of FIGS. 3B-3E. In particular, FIG. 4A is a schematic plan view of a first major surface of the feed stalk printed circuit board 320-1, FIG. 4B is a schematic plan view of a second major surface of the feed stalk printed circuit board 320-1, and FIG. 4C is a schematic shadow plan view of feed stalk printed circuit board 320-1.

As shown in FIGS. 4A-4C, the feed stalk printed circuit board 320-1 is implemented using a printed circuit board that includes a single dielectric substrate 322 that has first and second metallization patterns 324-1, 324-2 provided on the respective major surfaces thereof. The first metallization pattern 324-1 may be substantially identical to the first metallization pattern 224-1 shown in FIG. 3B, so further description thereof will be omitted. Referring to FIG. 4B, the second metallization pattern 324-2 comprises both the signal line 240 and the metamaterial structures 250 that are formed on the respective second and third metallization patterns 224-2, 224-3 of the first feed stalk printed circuit board 220-1 of FIGS. 3B-3E. The metamaterial structures 250 (which again are shown as being implemented as complementary split ring resonators 252 as an example) are spaced slightly farther apart in the second metallization pattern 324-2 so that the first and third segments 242-2, 242-3 of the signal trace 240 may overlap the first and second ground lines 246-1, 246-2, respectively. The cloaking performance of the first feed stalk printed circuit board 320-1 may not be quite as good as the cloaking performance of the first feed stalk printed circuit board 220-1 since the metamaterial structures 250 do not fully overlap the respective ground lines 246-1, 246-2, but the cost may be reduced since a single layer printed circuit board is used.

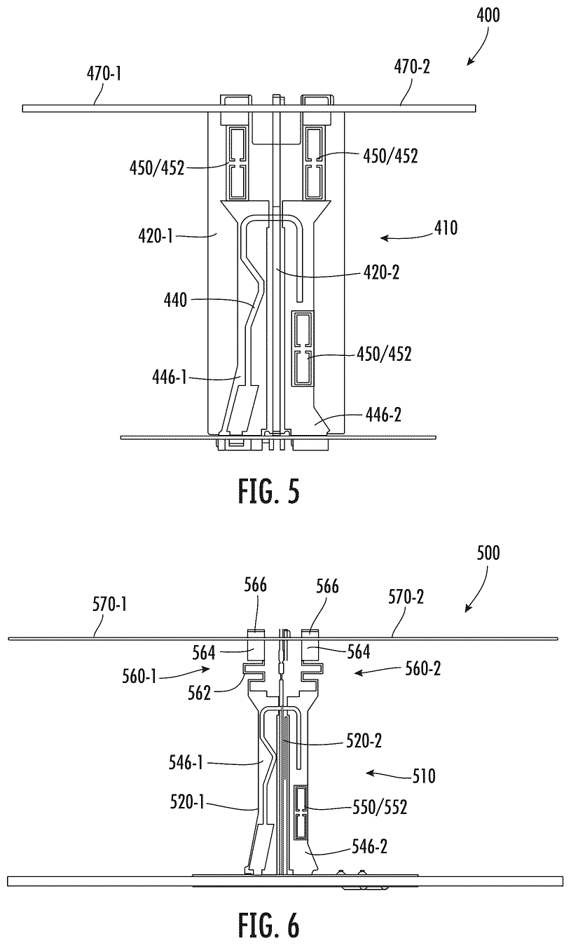

FIG. 5 is a schematic shadow side view of a low-band radiating element 400 according to further embodiments of the present invention. The low-band radiating element 400 includes a feed stalk 410 and first and second dipole radiators 470-1, 470-2. The dipole radiators 470-1, 470-2 may be identical to dipole radiators 70 described above with reference to FIGS. 1A-1B, and hence further description thereof will be omitted here.

The feed stalk 410 comprises first and second feed stalk printed circuit boards 420-1, 420-2. The feed stalk printed circuit boards 420-1, 420-2 may be identical to the feed stalk printed circuit boards 20-1, 20-2 of the conventional radiating element 1 of FIGS. 1A-1B, except that the front side of each feed stalk printed circuit board 420-1, 420-2 includes metamaterial structures 450. For example, as shown in FIG. 5, first through third complementary split ring resonators 452 are formed on the front side of feed stalk printed circuit board 420-1. Each complementary split ring resonator 452 overlaps a respective portion of one of a pair of twin ground lines 446-1, 446-2. The complementary split ring resonators 452 may be designed to cancel high-band currents that would otherwise form thereon, and hence may act to make the feed stalk printed circuit board 420-1 more transparent to RF energy in the high-band frequency range.

The complementary split ring resonators 452 may act to make the portions of the twin ground lines 446-1, 446-2 that they overlap transparent to high-band RF energy. This may advantageously “break up” metal structures such as the twin ground lines 446-1, 446-2 that may have lengths that are resonant in the high band frequency range into a plurality of smaller metal structures that may not be resonant in the high-band frequency range. This may further contribute to rendering the feed stalk printed circuit boards 420 more transparent to RF energy in the high-band energy range. Consequently, the impact of the feed stalk printed circuit board 420-1 on the antenna beams generated by a high-band array mounted rearwardly of radiating element 400 may be significantly reduced, thereby improving the performance of the high-band array. The feed stalk printed circuit board 420-2 may have substantially the same design as feed stalk printed circuit board 420-1 except that the location of the slits may be reversed and the shape of the signal line 440 on the second feed stalk printed circuit board 420-2 adjusted accordingly, in the same manner as is discussed above with respect to the second feed stalk printed circuit board 220-2.

FIG. 6 is a schematic shadow side view of a low-band radiating element 500 with cloaked feed stalk printed circuit boards according to additional embodiments of the present invention. The low-band radiating element 500 includes a feed stalk 510 and first and second dipole radiators 570-1, 570-2. The dipole radiators 570-1, 570-2 may be identical to dipole radiators 70 described above with reference to FIGS. 1A-1B, and hence further description thereof will be omitted here.

The feed stalk 510 comprises first and second feed stalk printed circuit boards 520-1, 520-2. The feed stalk printed circuit boards 520-1, 520-2 may be identical to the feed stalk printed circuit boards 20-1, 20-2 of the conventional radiating element 1 of FIGS. 1A-1B, except that the forward (distal) end of each ground line 546-1, 546-2 is modified to include a series inductor-capacitor (L-C) circuit 560-1, 560-2. In particular, the forward portion of each ground line 546-1, 546-2 (note that the ground lines 546-1, 546-2 are implemented on the rear side of the feed stalk printed circuit board 520-1) includes a narrowed meander trace 562 that forms a respective inductor. The forward portion of each ground line 546-1, 546-2 also includes a plate 564 that is connected in series to the respective meandered traces 562. Respective plates 566 are also provided on the front side of the feed stalk printed circuit board 520-1 that overlap the plates 564 so that each pair of a plate 564, 566 forms a respective capacitor. In other words, the meandered traces 562 and the plates 564, 566 form a pair of series LC circuits at the forward portion of each ground line 546-1, 546-2.

The LC circuits formed in the forward portion of the ground lines 546-1, 546-2 may be tuned to pass RF energy in the low-band operating frequency band while rejecting (blocking) RF energy in the operating frequency band of other nearby radiating elements that operate in different frequency bands, such as the operating frequency band of a nearby beamforming array 160. Thus, the LC circuits may act as a filter that blocks high-band currents. It will be appreciated that the above-described filter may be implemented in other locations along either or both of the twin ground lines 546-1, 546-2, and/or that more than one such filter may be provided along either or both of the twin ground lines 546-1, 546-2. The LC circuits may also be designed to provide appropriate impedance matching between the RF transmission lines in the feed stalk printed circuit boards 520-1, 520-2 and the dipole radiators 570-1, 570-2.

As is further shown in FIG. 6, one or more metamaterial structures 550 may also be provided on feed stalk printed circuit board 520-1. For example, one or more complementary split ring resonators 552 may be formed on the front side of feed stalk printed circuit board 520-1 that overlap a respective portion of one of the ground lines 546-1, 546-2. The complementary split ring resonators 552 may be designed to cancel high-band currents that would otherwise form thereon, and hence may act to make the feed stalk printed circuit board 520-1 more transparent to RF energy in the high-band frequency range.

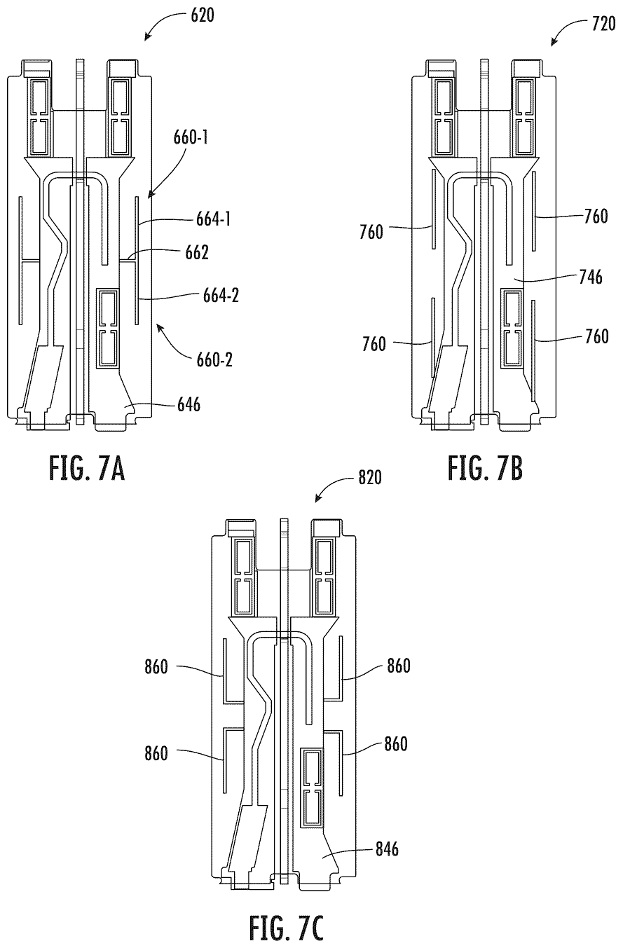

FIGS. 7A-7C are schematic shadow plan views of cloaked feed stalk printed circuit boards 620, 720, 820, respectively, according to further embodiments of the present invention. The cloaked feed stalk printed circuit boards 620, 720, 820 may be used, for example, in the radiating element 200 of FIG. 3A in place of feed stalk printed circuit board 220-1 (and feed stalk printed circuit board 220-2 would similarly be replaced with a feed stalk printed circuit board that is similar to feed stalk printed circuit boards 620, 720, 820, but with a different slit).

The feed stalk printed circuit boards 620, 720, 820 may be identical to the feed stalk printed circuit board 420-1 of FIG. 5, except that feed stalk printed circuit boards 620, 720, 820 each further include open-circuited stubs 660, 760, 860 that are connected to the ground lines 646, 746, 846 of the respective feed stalk printed circuit boards 620, 720, 820. The electrical lengths of the stubs open-circuited stubs 660, 760, 860 may be selected so that each stub 660, 760, 860 functions as a bandstop filter. In example embodiments, the electrical length of each stub 660, 760, 860 may be between 0.2 and 0.3 of the center wavelength of nearby radiating elements (e.g., the high-band beamforming array 160) in order to suppress currents forming on the ground lines 646, 746, 846 of the respective feed stalk printed circuit boards 620, 720, 820 in response to RF radiation emitted by such radiating elements.

In the embodiment of FIG. 7A, two open-circuited stubs 660-1, 660-2 extend from each ground line 646. The two open-circuited stubs 660-1, 660-2 share a first segment 662 and each have a second segment 664-1, 664-2 that extends from the shared first segment 662. In the embodiment of FIG. 7B, two open-circuited stubs 760 extend from each ground line 746, but in this case the open-circuited stubs 760 are spaced apart from each other and do not share a common segment. The embodiment of FIG. 7C is similar to the embodiment of FIG. 7B, but the open-circuited stubs 860 are in different positions and have different shapes.

While the embodiments of FIGS. 7A-7C include two open-circuited stubs per ground line, it will be appreciated that embodiments of the present invention are not limited thereto. In other embodiments, fewer (1) or more (3, 4, 5 or more) open-circuited stubs may extend from each ground line. It will also be appreciated that the number of open-circuited stubs extending from each ground line need not be the same. While the stubs are shown as being formed on the same side of the feed stalk printed circuit board as the ground lines, it will also be appreciated that some or all of the stubs may be formed on the other side of the feed stalk printed circuit board, or that some or all of the stubs can have portions on both sides of the feed stalk printed circuit board. It will also be appreciated that open-circuited stubs may be added to any of the feed stalks according to embodiments of the present invention that are discussed herein to further suppress formation of currents thereon in response to RF radiation emitted by nearby radiating elements.

FIGS. 8A and 8B are schematic perspective views of cloaked coaxial cables 900, 901 according to embodiments of the present invention. As discussed above with reference to FIGS. 2A-2B, in some passive/active antenna systems, a plurality of low-band radiating elements (and potentially, mid-band radiating elements) may be mounted in front of a beamforming array of high-band radiating elements. For example, as described above with reference to FIGS. 2A-2B, in some cases, a passive reflector assembly 120 of the passive base station antenna 110 of a passive/active antenna system 100 many include an opening 126, and a frequency selective surface may cover this opening 126. Low-band radiating elements 132 may be mounted on the frequency selective surface and may be directly in front of high-band radiating elements 162 of a beamforming array 160 included in the active antenna module 150 of passive/active antenna system 100. The low-band radiating elements 132 are typically mounted on feed board printed circuit boards. In order to feed RF signals to the low-band radiating elements, a pair of coaxial cables (one for each polarization) are typically connected to each feed board printed circuit board. Unfortunately, these coaxial cables can act to scatter RF energy emitted by the beamforming array 160.

As shown in FIGS. 8A-8B, pursuant to further embodiments of the present invention, coaxial cables are provided that have metamaterial structures printed or otherwise formed on their outer protective jackets. Referring first to FIG. 8A, a coaxial cable 900 includes a central conductor 910, a dielectric spacer 920, an outer conductor 930 and an insulating cable jacket 940. Each of these components of coaxial cable 900 may be conventional. Additionally, a plurality of metamaterial structures 950 are formed on the cable jacket 940. Each metamaterial structure 950 may comprise a metal pattern that is, for example, printed on an outer surface of the cable jacket 940. The metamaterial structures 950 may be designed to make the coaxial cable 900 more transparent to RF energy in one or more frequency ranges, thereby decreasing the extent to which the coaxial cable 900 scatters RF energy in these frequency ranges. In the depicted embodiment, each metamaterial structure 950 comprises a complementary split ring resonator 952. The complementary split ring resonator 952 are arranged along a longitudinal axis of the coaxial cable 900. It will be appreciated that split ring resonators or other metamaterial structures may be used in other embodiments.

In the embodiment of FIG. 8A, a single line of complementary split ring resonators 952 is formed on the cable jacket 940. As shown in FIG. 8B, in other embodiments, coaxial cables 901 are provided that include more than one line of metamaterial structures 950 may be formed on the cable jacket 940.

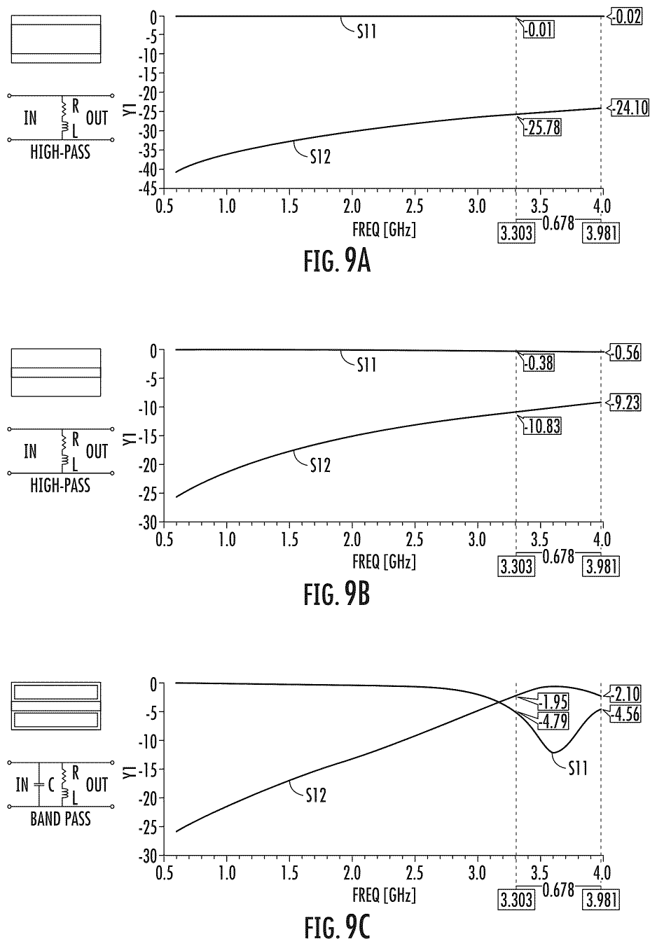

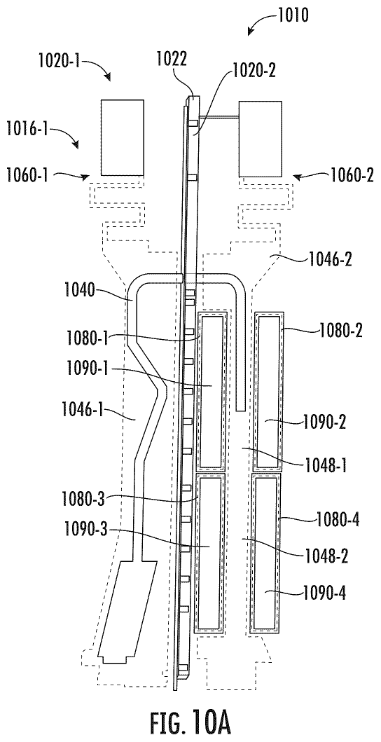

FIGS. 9A-9C are graphs that illustrate the S11 (return loss) and S12 (insertion loss) s-parameters for several conductive structures to RF energy incident thereon. In each figure, the conductive structure is shown at the top left, the s-parameters are shown in the graph, and the equivalent circuit of the metal structure is shown at the bottom left. Port 1 (the source) may be viewed as being in front of the metal structure (i.e., above the page) and Port 2 may be viewed as being behind the metal structure (i.e., behind the page). The S11 curve in each graph illustrates, as a function of frequency, the amount of energy measured at Port 1 in response to an RF signal emitted from Port 1 toward the conductive structure (i.e., the percentage of the emitted RF energy that is reflected back to Port 1). The S12 curve in each graph illustrates, as a function of frequency, the amount of energy measured at Port 2 in response to an RF signal emitted from Port 1 toward the conductive structure (i.e., the percentage of the emitted RF energy that passes through/around the conductive structure).

As shown in FIG. 9A, a wide conductive trace may be viewed as a series resistor-inductor (R-L) circuit that will provide a high-pass response. As shown by the S12 curve in the graph in FIG. 9A, the wide trace passes an increasing percentage of incident RF energy with increasing frequency and generally has a high-pass response, albeit with very poor selectivity (i.e. there are no sharp changes in the S11 or S12 responses, instead the transmission characteristic change very gradually with frequency). The wide trace reflects almost all of the incident energy across the 0.5-4.0 GHz frequency range, but at higher frequencies (not shown in the graph) non-trivial amounts of RF energy start to pass to Port 2.

Referring to FIG. 9B, the value of the inductance L of the series resistor-inductor (R-L) circuit may be increased by reducing the width of the conductive trace. The increased inductance acts to shift the response to lower frequencies so that the circuit starts to pass a greater portion of the incident RF energy at a lower frequency than is the case for the circuit of FIG. 9A. For example, FIG. 9B shows that more than 10% of the RF energy is passed at 4.0 GHz.

As shown in FIG. 9C, by adding metal stubs on each side of the narrowtrace, a capacitance (C) is added in parallel to the series resistor-inductor (R-L) circuit formed by the narrow trace. This allows the circuit to have a bandpass response. As shown in the graph, a null appears in the return loss (S11) curve in the 3.4-4.0 GHz frequency range, indicating that in this frequency range the structure shown on the left side of FIG. 9C may be relatively invisible or “cloaked” to RF energy.

As discussed above, the twin ground lines included in the feed stalks of lower-band radiating elements can potentially act to scatter RF energy emitted by nearby higher-band radiating elements, since the ground lines may be resonant within the operating frequency band of the higher-band radiating elements and/or may reflect the RF energy. By adding one or more metal stubs that run alongside one or more sections of the ground line(s), a parallel L-C circuit can be created that can be tuned to have a bandpass response in the operating frequency band of the higher-band radiating elements, thereby making the ground line more transparent to RF energy in the operating frequency band of the higher-band radiating element. Pursuant to further embodiments of the present invention, lower-band radiating elements are provided that use this technique so that the feed stalks of these lower-band radiating elements are cloaked in an appropriate frequency range.

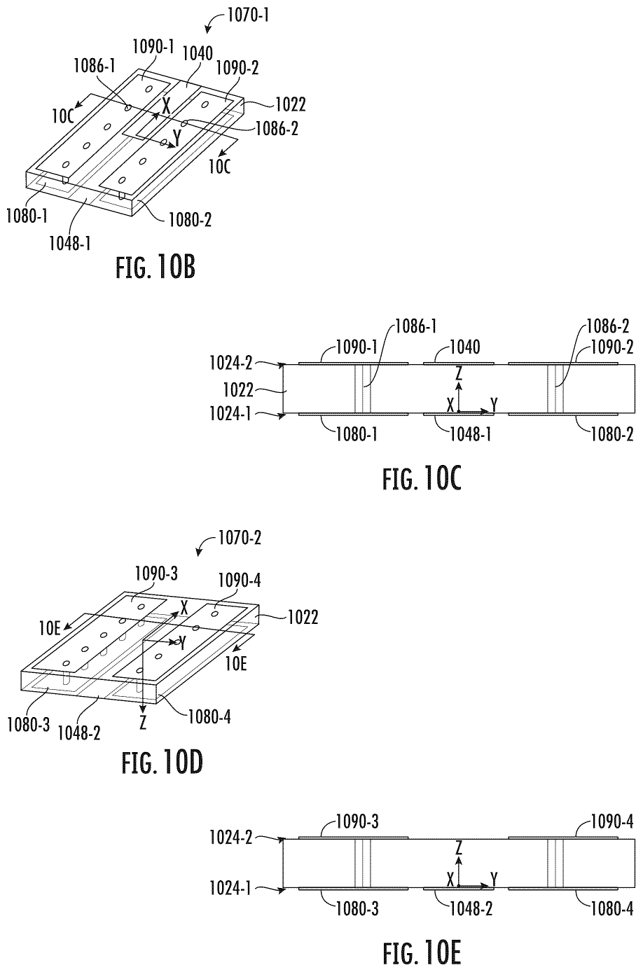

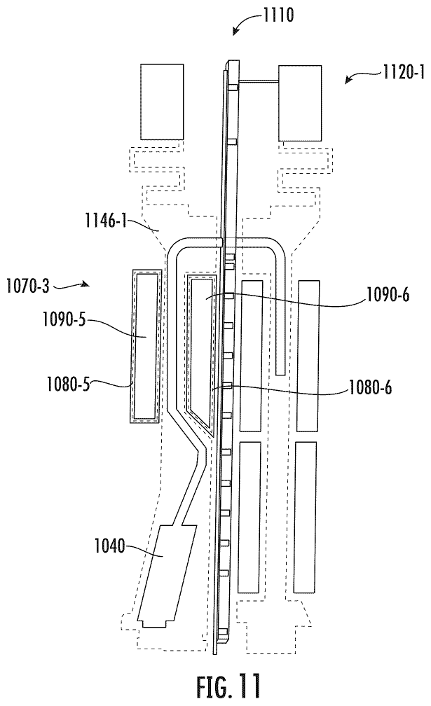

FIGS. 10A-10E schematically illustrate the design of the feed stalk 1010 of a radiating element according to further embodiments of the present invention. In particular, FIG. 10A is a schematic shadow side view of the feed stalk 1010. FIG. 10B is a schematic shadow perspective view of a cloaked portion of a ground line included on one of the feed stalk printed circuit boards of the feed stalk 1010. FIG. 10C is a schematic cross-sectional view taken along line 10C-10C of FIG. 10B. FIG. 10D is a schematic shadow perspective view of another cloaked portion of the ground line included on one of the feed stalk printed circuit boards of the feed stalk 1010. Finally, FIG. 10E is a schematic cross-sectional view taken along line 10E-10E of FIG. 10D. Any appropriate dipole radiators (e.g., the dipole radiators 70 described above with reference to FIG. 1A) may be mounted on the feed stalk 1010 to form a lower-band radiating element. The lower-band radiating element including feed stalk 1010 may, for example, be a low-band radiating element that is configured to operate in the 696-960 MHz frequency range.

Referring to FIG. 10A, the feed stalk 1010 comprises first and second feed stalk printed circuit boards 1020-1, 1020-2. Each feed stalk printed circuit board 1020 has a base and a distal end that is positioned forwardly of the base. The dipole radiators of the radiating element are mounted at the distal ends of the feed stalk printed circuit boards 1020 (the distal ends are the top ends in FIG. 10A). The first and second feed stalk printed circuit boards 1020-1, 1020-2 include respective slits that are similar or identical to the slits in the feed stalk printed circuit boards 220 (see FIGS. 3A-3B above), so further description of these slits will be omitted here.

Each feed stalk printed circuit board 1020 is implemented using a printed circuit board that includes a respective dielectric substrate 1022. In FIG. 10A (and in FIG. 11, which is described below), the dielectric substrate 1022 for the first feed stalk printed circuit board 1020-1 is omitted to simplify the drawing, but the dielectric substrate 1022 for the second feed stalk printed circuit board 1020-2 is shown in the drawing. First and second metallization patterns 1024-1, 1024-2 are provided on the respective major surfaces of the dielectric substrate 1022 for the first feed stalk printed circuit board 1020-1. FIG. 10A is a shadow view with the first metallization pattern 1024-1 which is on the back side of the dielectric substrate 1022 illustrated using dashed lines.

As shown in FIG. 10A, the first metallization pattern 1024-1 comprises a twin line transmission line structure that comprises first and second metal ground lines 1046-1, 1046-2 that extend from a base of the first feed stalk printed circuit board 1020-1 to a distal end thereof. Each ground line 1046-1, 1046-2 is coupled to the ground conductor of a first RF transmission line (not shown) that connects to the feed stalk 1010. The first and second ground lines 1046-1, 1046-2 may each have an electrical length of about ¼ the center wavelength of the radiating element that includes feed stalk 1010. The forward portion of each ground line 1046-1, 1046-2 includes a respective series L-C circuit 1060-1, 1060-2, which may be identical to the series L-C circuits 560-1, 560-2 that are included in the feed stalk printed circuit boards 520 of FIG. 6. As discussed with reference to FIG. 6, the L-C circuits formed in the forward portion of the ground lines 1046-1, 1046-2 may be tuned to pass RF energy in the low-band operating frequency band while rejecting (blocking) RF energy in the operating frequency band of other nearby radiating elements that operate in different frequency bands, such as the operating frequency band of a nearby beamforming array 160. Thus, the L-C circuits may act as a filter that blocks high-band currents. The L-C circuits 1060 may also be designed to provide appropriate impedance matching between the RF transmission lines in the feed stalk printed circuit boards 1020-1, 1020-2 and the dipole radiators.

As can further be seen from FIG. 10A, first and second sections 1048-1, 1048-2 of the second ground line 1046-2 are narrower than the first ground line 1046-1 and narrower than other portions of the second ground line 1046-2. In addition, first and second metal stubs 1080-1, 1080-2 are positioned on opposed sides of the first section 1048-1 of the second ground line 1046-2. A third metal stub 1080-3 is positioned rearwardly of the first metal stub 1080-1, and a fourth metal stub 1080-4 is positioned rearwardly of the second metal stub 1080-2. The third and fourth metal stubs 1080-3, 1080-4 are positioned on opposed sides of the second section 1048-2 of the second ground line 1046-2. Narrowing the width of the first and second sections 1048-1, 1048-2 of the second ground line 1046-2 as compared to the first ground line 1046-1 (and as compared to the remainder of the second ground line 1046-2) provides room in the first metallization pattern 1024-1 on the feed stalk printed circuit board 1020-1 for the first through fourth metal stubs 1080-1 through 1080-4. The first through fourth metal stubs 1080-1 through 1080-4 are part of the first metallization pattern 1024-1. The function and operation of the metal stubs 1080 will be discussed in more detail below with reference to FIGS. 10B-10E.

The second metallization pattern 1024-2 comprises a signal line 1040 that is coupled to the signal conductor of the RF transmission line (not shown) that feeds the first feed stalk printed circuit board 1020-1. The signal line 1040 extends forwardly from the base of the first feed stalk printed circuit board 1020-1 and travels about two-thirds of the way toward the distal end thereof. The signal line 1040 then goes through a first 90° turn to extend transversely across the first side of feed stalk printed circuit board 1020-1. Finally, the signal line 1040 goes through a second 90° turn to extend rearwardly toward the base of the first feed stalk printed circuit board 1020-1, dividing the signal line 1040 into a forwardly extending segment, a transversely extending segment, and a rearwardly extending segment. The forwardly extending segment overlaps the first ground line 1046-1. The transversely extending segment extends from the end of the forwardly extending segment, to cross over a gap 1036 (i.e., an unmetallized region) that is provided between the first and second ground lines 1046-1, 1046-2. The transversely extending segment overlaps portions of both the first ground line 1046-1 and the second ground line 1046-2. The rearwardly extending segment overlaps the second ground line 1046-2.

The second metallization pattern 1024-2 further comprises four additional metal stubs 1090-1 through 1090-4, with the first and second additional metal stubs 1090-1, 1090-2 positioned on opposed sides of the rearwardly extending segment of the signal trace 1040, and the third and fourth additional metal stubs 1090-3, 1090-4 positioned immediately rearward of the respective first and second additional metal stubs 1090-1, 1090-2. The function and operation of the additional metal stubs 1090 will be discussed in more detail below with reference to FIGS. 10B-10E. The signal trace 1040 and the first and second ground lines 1046-1, 1046-2 together form an RF feed line 1016-1 that carries RF signals between an RF transmission line (not shown) of the feed network for a radiating element that includes feed stalk 1010 and a dipole radiator thereof.

FIG. 10B is a schematic perspective view of a small portion of the first feed stalk printed circuit board 1020-1 in the vicinity of the distal end of the signal line 1040. FIG. 10C is a schematic cross-sectional view taken along line 10C-10C of FIG. 10B.

With reference to FIGS. 10A-10E, the first and second metal stubs 1080-1, 1080-2 are formed in the same metallization layer (layer 1024-1) as the second ground line 1046-2 and extend in parallel to first (narrowed) section 1048-1 of the second ground line 1046-2 and in close proximity thereto. As such, the first section 1048-1 of the second ground line 1046-1 and the first and second metal stubs 1080-1, 1080-2 form a first resonant structure 1070-1 that has the design of the resonant structure discussed above with reference to FIG. 9C. As discussed above, the lengths of the first and second metal stubs 1080-1, 1080-2 may be set so that the resonant structure 1070-1 exhibits a band-pass response with in a desired frequency range, such as the frequency range of a nearby higher-band radiating element. Similarly, the third and fourth metal stubs 1080-3, 1080-4 are also formed in the first metallization layer 1024-1 along with the second ground line 1046-2 and extend in parallel to the second (narrowed) section 1048-2 of the second ground line 1046-2 and in close proximity thereto. As such, the second section 1048-2 of the second ground line 1046-1 and the third and fourth metal stubs 1080-3, 1080-4 form a second resonant structure 1070-2 that also has the design of the resonant structure discussed above with reference to FIG. 9C. The lengths of the first and second metal stubs 1080-1, 1080-2 and the lengths of the third and fourth metal stubs 1080-3, 1080-4 may be set so that the above-discussed first and second resonant structures 1070-1, 1070-2 each exhibit a band-pass response within a desired frequency range, such as the frequency range of a nearby higher-band radiating element. In other words, by making sections of the second ground line 1046-2 narrower and positioning the metal stubs 1080 on either side thereof, the illustrated portions of the ground line in FIGS. 10B and 10D may be made much more transparent with respect in the operating frequency band of a nearby radiating element.

Unfortunately, narrowing the width of the first and second sections 1048-1, 1048-2 of the second ground line 1046-2 may degrade the impedance match between the RF transmission line 1016-1 and the dipole radiator mounted on the first feed stalk printed circuit board 1020-1. This may increase the return loss of the lower-band radiating element, narrowing its operating bandwidth. In order to offset this impedance degradation, the additional metal stubs 1090 are provided in the second metallization layer 1024-2. The additional metal stubs 1090 may, for example, be identical to the metal stubs 1080 and may exactly overlap the metal stubs 1080 in some embodiments. As can further be seen, plated through holes 1086 extend through the dielectric substrate 1022 that galvanically connect the first through fourth metal stubs 1080-1 through 1080-4 to the first through fourth additional metal stubs 1090-1 through 1090-4.

As shown in FIGS. 10B and 10C, a portion of the signal line 1040-1 may extend in between the first and second additional metal stubs 1090-1, 1090-2. As shown in FIGS. 10D and 10E, the signal line 1040-1 does not extend in between the third and fourth additional metal stubs 1090-3, 1090-4. The portion of the first feed stalk printed circuit board 1020-1 shown in FIGS. 10B-10C may be viewed as a first cell of a frequency selective surface and the portion of the first feed stalk printed circuit board 1020-1 shown in FIGS. 10D-10E may be viewed as a second cell of the frequency selective surface.

Thus, pursuant to further embodiments of the present invention, radiating elements are provided that comprise a feed stalk 1010 having a signal line 1040, a ground line 1046-2 and a first metal stub 1080-1 that extends in parallel to a first section 1048-1 of the ground line 1046-2, and a radiator (not shown) mounted on the feed stalk 1010. The first metal stub 1080-1 is configured to capacitively couple with the first section 1048-1 of the ground line 1046-2.

Pursuant to additional embodiments of the present invention, radiating elements are provided that comprise a feed stalk 1010 having a signal line 1040 and a ground line 1046-2, and a radiator mounted on the feed stalk 1010. In these radiating elements, a first section 1048-1 of the ground line 1046-2 is part of a resonant circuit 1070-1 that is configured to have a band pass response in a preselected frequency range.

Pursuant to still further embodiments of the present invention, radiating elements are provided that comprise a feed stalk printed circuit board 1020-1 having a signal line 1040, a ground line 1046-2, first and second metal stubs 1080-1, 1080-2 that are opposed sides of a first section 1048-1 of the ground line 1046-2, and first and second additional metal stubs 1090-1, 1090-2 that overlap the respective first and second metal stubs 1080-1, 1080-2. The radiating element may further include a radiator mounted on the feed stalk 1010.

In some embodiments, the signal line 1040, the ground line 1046-2 and the first metal stub 1080-1 are implemented on a feed stalk printed circuit board 1020-1. In some embodiments, the first metal stub 1080-1 is not galvanically connected to either the ground line 1046-2 or the signal line 1040. In some embodiments, a width of the first section 1048-1 of the ground line 1046-2 is less than half a width of another section of the ground line 1046-2.

In some embodiments, the radiating element further comprises a second metal stub 1080-2 that extends in parallel to the first section 1048-1 of the ground line 1046-2, where the second metal stub 1080-2 is configured to capacitively couple with the first section 1048-1 of the ground line 1046-2. In some embodiments, the first metal stub 1080-1 is on a first side of the first section 1048-1 of the ground line 1046-2 and the second metal stub 1080-2 is on a second side of the first section 1048-1 of the ground line 1046-2 that is opposite the first side. In some embodiments, the first metal stub 1080-1, the second metal stub 1080-2 and the first section 1048-1 of the ground line 1046-2 are all on a first metallization layer 1024-1 of the feed stalk printed circuit board 1020-1.

In some embodiments, the radiating element further comprises third and fourth metal stubs 1080-3, 1080-4 that extend in parallel to a second section 1048-2 of the ground line 1046-2 and that are configured to capacitively couple with the second section 1048-2 of the ground line 1046-2.

In some embodiments, the radiating element further comprises a first additional metal stub 1090-1 that overlaps the first metal stub 1080-1 and a second additional metal stub 1090-2 that overlaps the second metal stub 1080-2, where the first and second additional metal stubs 1090-1, 1090-2 and at least a first portion of the signal line 1040 are all on a second metallization layer 1024-2 of the feed stalk printed circuit board 1020-1 that is different than the first metallization layer 1024-1. In some embodiments, a first conductive via 1086-1 in the feed stalk printed circuit board 1020-1 galvanically connects the first metal stub 1080-1 to the first additional metal stub 1090-1, and a second conductive via 1086-2 in the feed stalk printed circuit board 1020-1 galvanically connects the second metal stub 1080-2 to the second additional metal stub 1090-2. In some embodiments, the first portion of the signal line 1040 is between the first and second additional metal stubs 1090-1, 1090-2.

In some embodiments, the first metal stub 1080-1 and the first section 1048-1 of the ground line 1046-2 together comprise at least a portion of an inductor-capacitor circuit 1070-1 that has a band pass filter response. In some embodiments, the radiating element is part of a base station antenna, and the base station antenna includes a second radiating element that has an operating frequency band, and a frequency in the band pass filter response having the highest transmission level is within the operating frequency band.

Simulations show that the feed stalk 1010 may exhibit good cloaking performance throughout the 3.4-4.0 GHz frequency band. For example, assuming that an array of higher-band (3.4-4.0 GHZ) radiating elements is mounted rearwardly of feed stalk 1010 and is not electronically scanned (0° scan angle in the azimuth plane), the feed stalk 1010 may exhibit good cloaking performance across the entire 3.4-4.0 GHz frequency band. The same results are seen when the array of higher-band radiating elements is electronically scanned to 45° in the azimuth plane. Simulations show that the return loss of the RF transmission line 1016-1 is better than-11.85 dB across the full 696-960 MHz operating frequency band, and the return loss performance can likely be improved to exceed-15 dB through optimization.

FIG. 11 is a schematic side view of a feed stalk 1110 of a radiating element according to still further embodiments of the present invention. The feed stalk 1110 may be nearly identical to the feed stalk 1010 of FIGS. 10A-10E, so the discussion below will focus solely on the differences between the two feed stalks.

As shown in FIG. 11, a first ground line 1146-1 that is formed in the first metallization pattern 1024-1 of the first feed stalk printed circuit board 1120-1 of feed stalk 1110 includes a narrowed section. The first metallization pattern 1024-1 further includes fifth and sixth metal stubs 1080-5, 1080-6 that are formed on opposed sides of the narrowed section of the first ground line 1146-1. The narrowed section of the first ground line 1146-1 and the fifth and sixth metal stubs 1080-5, 1080-6 form a third resonant structure 1070-3. The third resonant structure 1070-3 may be configured to render the first ground line 1146-1 more transparent to RF energy in an operating frequency band of a nearby higher-band radiating element. The second metallization pattern 1024-2 further includes fifth and sixth additional metal stubs 1090-5, 1090-6 that are formed on opposed sides of the signal line 1040.

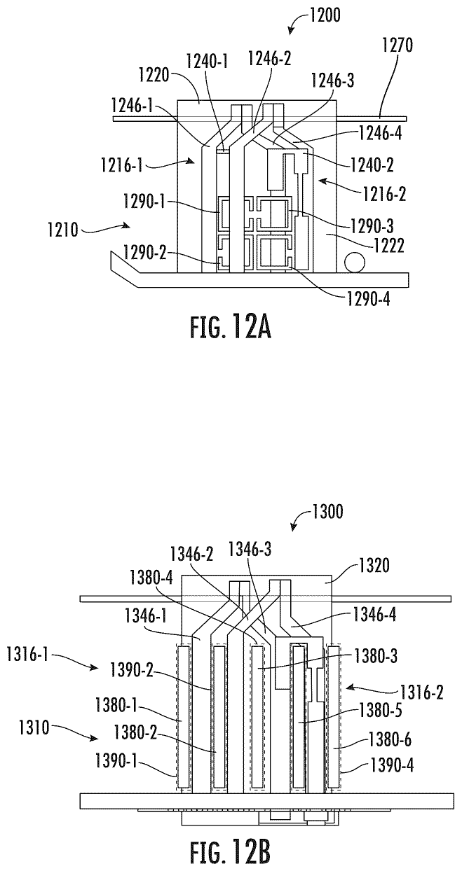

FIG. 12A is a schematic shadow side view of a mid-band radiating element 1200 according to additional embodiments of the present invention. As shown in FIG. 12A, the radiating element 1200 includes a feed talk 1210 and a dipole radiator printed circuit board 1270. The dipole radiator printed circuit board 1270 includes first through fourth dipole arms (not visible in FIG. 12A) that are arranged as first and second dipole radiators (not visible in FIG. 12A). The first and second dipole radiators may be any appropriate dipole radiator design. For example, the first and second dipole radiators may be identical to the dipole radiators 70-1, 70-2 discussed above with reference to FIG. 1A.

The feed stalk 1210 is formed as a single feed stalk printed circuit board 1220. The feed stalk printed circuit board 1220 includes a first RF transmission line 1216-1 that feeds the first dipole radiator and a second RF transmission line 1216-2 that feeds the second dipole radiator. The feed stalk printed circuit board 1220 includes a dielectric substrate 1222 with first and second metallization patterns formed on the major surfaces thereof. The grounds lines 1246-1, 1246-2 for the first RF transmission line 1216-1 and the signal line 1240-2 for the second RF transmission line 1216-2 are (primarily) formed in the second metallization pattern, while the grounds lines 1246-3, 1246-4 for the second RF transmission line 1216-2 and the signal line 1240-1 for the first RF transmission line 1216-1 are (primarily) formed in the first metallization pattern. Small forward portions of the first and third groundlines 1246-1, 1246-3 are formed in the other one of the first and second metallization patterns from the remainder of the respective first and third groundlines 1246-1, 1246-3. A variety of designs for cross-dipole radiating elements having a single feed stalk printed circuit board are disclosed in PCT Patent Application No. PCT/CN2022/104848 (“the '848 application”), the entire content of which is incorporated herein by reference.

The feed stalk printed circuit board 1220 differs from the feed stalk printed circuit boards disclosed in the '848 application in that split ring resonators 1290 are provided in the first and second metallization patterns. In particular, the first metallization pattern includes first and second split ring resonators 1290-1, 1290-2 that are used to cloak a portion of the second ground line 1246-2, and the second metallization pattern includes third and fourth split ring resonators 1290-3, 1290-4 that are used to cloak a portion of the fourth ground line 1246-4. The split ring resonators 1290 act to cloak the second and fourth ground lines 1246-2, 1246-4 in the same manner that the complementary split ring resonators 452 in the radiating element 400 of FIG. 5 act to cloak corresponding ground lines 446-1, 446-2, and hence further description thereof will be omitted here.

FIG. 12B is a schematic shadow side view of a mid-band radiating element 1300 according to further embodiments of the present invention. As shown in FIG. 12B, the radiating element 1300 includes a feed stalk 1310 that is similar to the feed stalk 1210 of radiating element 1200 of FIG. 12A in that the feed stalk 1310 is formed using a single feed stalk printed circuit board 1320 that includes first and second RF transmission lines 1316-1, 1316-2 thereon that feed a pair of dipole radiators. However, the split ring resonators 1290 that are included on feed stalk 1210 are omitted in radiating element 1300 and replaced with a plurality of metal stubs 1380 and additional metal stubs 1390 that are formed adjacent the ground lines 1346-1 through 1346-4. In particular, metal stubs 1380-1, 1380-2 are provided on opposed sides of the first ground line 1346-1, metal stubs 1380-2, 1380-3 are provided on opposed sides of the second ground line 1346-2, metal stubs 1380-4, 1380-5 are provided on opposed sides of the third ground line 1346-3, and metal stubs 1380-5, 1380-6 are provided on opposed sides of the fourth ground line 1346-4. Metal stubs 1380-1 through 1380-3 are part of a second metallization pattern of feed stalk printed circuit board 1320, while metal stubs 1380-4 through 1380-6 are part of a first metallization pattern of feed stalk printed circuit board 1320. Additional metal stubs 1390-1, 1390-2 may be provided on the first metallization pattern to exactly overlap metal stubs 1390-1, 1390-2, respectively, and additional metal stubs 1390-3, 1390-4 may be provided in the second metallization pattern to exactly overlap metal stubs 1380-5, 1380-6, respectively. Plated through holes (not shown) may electrically connect each metal stub 1380 to a respective one of the additional metal stubs 1390 that the metal stub overlaps. Additionally, plated through holes 1386 may also electrically connect metal stub 1380-3 to metal stub 1380-4.

The metal stubs 1380 may add capacitances that, coupled with the inductance of the ground lines 1346, may form resonant circuits having band pass filter responses. The resonant circuits may be tuned to have pass bands within the operating frequency band of one or more nearby higher-band radiating elements in the same manner that the metal stubs 1080 of feed stalk 1010 are used to cloak the ground lines thereof. The additional metal stubs 1390 and plated through holes 1386 may be provided to better impedance match the RF transmission lines 1316 to the dipole radiators. Thus, FIG. 12B shows that the techniques discussed above with reference to FIGS. 10A-10E may be used on radiating elements that operate in other frequency bands and/or on radiating elements that have different feed stalk designs.

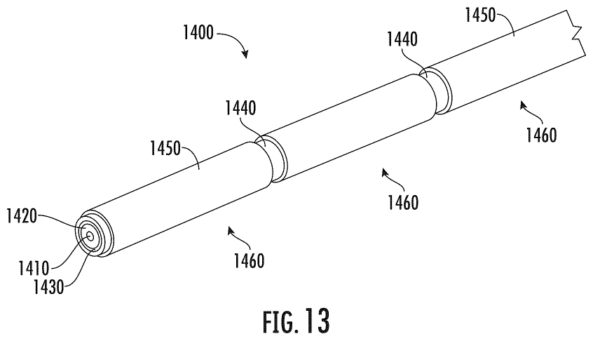

FIG. 13 is a schematic perspective view of a cloaked coaxial cable 1400 according to further embodiments of the present invention. Referring to FIG. 13, the coaxial cable 1400 includes a central conductor 1410, a dielectric spacer 1420, an outer conductor 1430 and an insulating cable jacket 1440. Each of these components of coaxial cable 1400 may be conventional. Additionally, coaxial cable 1400 further includes a plurality of spaced-apart metal stubs 1450 that are formed over the outer jacket 1440. The metal stubs 1450 may capacitively couple with the outer conductor 1430 to form respective resonant circuits 1460 that have band pass responses. The band pass responses of these resonant circuits 1460 may be tuned to be within the operating frequency band of nearby radiating elements (not shown), which may act to cloak the coaxial cables with respect to RF energy in the operating frequency band of these nearby radiating elements. Since the outer conductor 1430 of the coaxial cable 1400 may be relatively large, the inductance of the resonant circuits 1460 may be relatively small, which may result in a narrower pass band. Thus, this technique may be particularly well-suited for cloaking coaxial cables that are positioned near higher-band radiating elements having narrower operating frequency bands.

The metal stubs 1450 may comprise metal sleeves 1450 that are mounted directly on the cable jacket 1440. The metal sleeves 1450 may have an annular shape.

It will be appreciated that many modifications may be made to the radiating elements discussed above without departing from the scope of the present invention. For example, the above-described radiating elements are formed using feed stalk printed circuit boards. In other embodiments, other types of feed stalk implementations may be used such as, for example, sheet metal feed stalks. Likewise, while the dipole arms of the low-band radiating elements described above are implemented in dipole radiator printed circuit boards, it will be appreciated that embodiments of the present invention are not limited thereto. For example, in other embodiments, the dipole arms may be implemented as sheet metal dipole arms or using other metal structures.

The radiating elements according to embodiments of the present invention may be included in multi-band base station antennas, and may reduce the amount of interaction between the arrays in the different frequency bands. Base station antennas that include the radiating elements according to embodiments of the present invention may be used, for example, as sector antennas in the above-described cellular communications systems.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

Herein, the term “substantially” means within +/−10%.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

That which is claimed is:

1. A radiating element, comprising:
a feed stalk having a signal line, a first ground line and a ring-based metamaterial resonator; and
a radiator mounted on the feed stalk.

2. The radiating element of claim 1, wherein the ring-based metamaterial resonator overlaps the first ground line.

3. The radiating element of claim 2, wherein the ring-based metamaterial resonator comprises a complementary split ring resonator.

4. The radiating element of claim 2, wherein the ring-based metamaterial resonator comprises a split ring resonator.

5. The radiating element of claim 1, wherein the feed stalk comprises a first plurality of ring-based metamaterial resonators, with the ring-based metamaterial resonator being one of the first plurality of ring-based metamaterial resonators, and the first plurality of ring-based metamaterial resonators overlap at least 50% of the first ground line.

6. The radiating element of claim 5, wherein the feed stalk further comprises a second ground line and a second plurality of ring-based metamaterial resonators that overlap at least 50% of the second ground line.

7. The radiating element of claim 6, wherein the feed stalk comprises a feed stalk printed circuit board having a dielectric substrate with first and second metallization patterns on opposed first and second major surfaces thereof, with the signal line and the ring-based metamaterial resonator being at least part of the first metallization pattern and the first and second ground lines being at least part of the second metallization pattern.

8. The radiating element of claim 7, wherein the signal line comprises a first segment that overlaps the first ground line, a third segment that overlaps the second ground line and a second segment that connects the first segment to the third segment.

9. The radiating element of claim 8, wherein the signal line is in between the first plurality of ring-based metamaterial resonators and the second plurality of ring-based metamaterial resonators overlap the second ground line.

10. The radiating element of claim 1, wherein the feed stalk comprises a feed stalk printed circuit board having a first dielectric substrate with a first metallization pattern thereon, a second dielectric substrate with a third metallization pattern thereon and a second metallization pattern positioned between the first and second dielectric substrates, with the ring-based metamaterial resonator being part of the first metallization pattern, the signal line being at least part of the second metallization pattern, and the first ground line being part of the third metallization pattern.

11. The radiating element of claim 1, wherein the radiator is mounted on a forward end of the feed stalk, and the ring-based metamaterial resonator overlaps a portion of the first ground line that is positioned forwardly of the signal line.

12. A base station antenna, comprising:
a radiating element that is configured as the radiating element of claim 1; and
a second radiating element that is configured to operate in a higher operating frequency band than the first radiating element,
wherein the ring-based metamaterial resonator is configured to operate as a bandpass filter having a passband that encompasses at least a portion of the higher operating frequency band.

13. (canceled)

14. A radiating element, comprising:
a feed stalk printed circuit board that comprises at least a first dielectric substrate, a first metallization pattern that extends in a longitudinal direction of the feed stalk printed circuit board on a first outer surface of the dielectric substrate, and a second metallization pattern that comprises a plurality of ring-based metamaterial resonators; and
a radiator.

15. The radiating element of claim 14, wherein the first metallization pattern comprises first and second ground lines.

16. The radiating element of claim 15, wherein the second metallization pattern further comprises a signal line that is positioned between first and second of the ring-based metamaterial resonators in the plurality of ring-based metamaterial resonators.

17. The radiating element of claim 15, wherein the plurality of ring-based metamaterial resonators comprises a first plurality of ring-based metamaterial resonators and a second plurality of ring-based metamaterial resonators.

18. The radiating element of claim 17, wherein the first plurality of ring-based metamaterial resonators overlaps the first ground line.

19-20. (canceled)

21. The radiating element of claim 16, wherein the second metallization pattern is on a second outer surface of the first dielectric substrate.

22. The radiating element of claim 15, wherein the feed stalk printed circuit board further comprises a second dielectric substrate, wherein the second metallization pattern is on an outer surface of the second dielectric substrate, and the feed stalk further comprises a signal line that is part of a third metallization pattern that is positioned between the first and second dielectric substrates.

23. The radiating element of claim 22, wherein the signal line comprises a first segment that overlaps the first ground line, a third segment that overlaps the second ground line and a second segment that connects the first segment to the third segment.

24. The radiating element of claim 23, wherein the plurality of ring-based metamaterial resonators comprises a first plurality of ring-based metamaterial resonators and a second plurality of ring-based metamaterial resonators, wherein the first plurality of ring-based metamaterial resonators overlap the first ground line, and the second plurality of ring-based metamaterial resonators overlap the second ground line.

25-76. (canceled)
